(19) United States
(12) Patent Application Publication
(10) Pub. No.: US 2025/0240647 A1
(43) Pub. Date: Jul. 24, 2025

(54) NETWORK LAYER HETEROGENEITY

(71) Applicant: QUALCOMM Incorporated, San Diego, CA (US)

(72) Inventors: Srinivas YERRAMALLI, San Diego, CA (US); Eren BALEVI, Brooklyn, NY (US); Taesang YOO, San Diego, CA (US); Rajat PRAKASH, San Diego, CA (US)

(21) Appl. No.: 18/837,795

(22) PCT Filed: Mar. 24, 2023
(86) PCT No.: PCT/US23/16314

§ 371 Date: Aug. 12, 2024

(30) Foreign Application Priority Data
Apr. 5, 2022 (IN) 202241020427

(51) Int. Cl. H04W 24/02; H04L 41/16

(52) U.S. Cl. CPC H04W 24/02; H04L 41/16

(57) ABSTRACT

Disclosed are techniques for communication. In an aspect, a network component determines that a level of heterogeneity associated with a network layer of a hierarchical network layer arrangement with multiple network layers is above a threshold. In some designs, the heterogeneity level determination may be based on heterogeneity metric(s) reported by device(s) associated with the network layer. The network component may transmit, to at least one device associated with the network layer in response to the heterogeneity level determination, a data reporting instruction associated with the network layer. The network component receives data associated with the network layer from the at least one device in accordance with the data reporting instruction.

### CROSS-REFERENCE TO RELATED APPLICATIONS

The present Application for Patent claims priority under 35 U.S.C. § 371 to International Patent Application No. PCT/US2023/016314, entitled “NETWORK LAYER HETEROGENEITY,” filed Mar. 24, 2023, and to Indian Patent Application number 202241020427, entitled “NETWORK LAYER HETEROGENEITY,” filed Apr. 5, 2022, each of which is assigned to the assignee hereof and expressly incorporated herein by reference in their entirety.

### BACKGROUND OF THE DISCLOSURE

### 1. Field of the Disclosure

Aspects of the disclosure relate generally to wireless communications.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), and other technical enhancements. These enhancements, as well as the use of higher frequency bands, advances in PRS processes and technology, and high-density deployments for 5G, enable highly accurate 5G-based positioning.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Network layers may be defined so as to group similar device types, such as user equipments (UEs) (e.g., over-the-air (OTA) layer or Level-0), remote units (RUS) (e.g., RU layer or Level-1), distributed units (DUs) (e.g., DU layer or Level-2), centralized units (CUs) (e.g., CU layer or Level-3), core network (CN) (e.g., CN layer or Level-4), and so on. In some designs, various data can be aggregated across multiple devices at each respective network layer for analysis at a network component (e.g., CU, CN, etc.). For example, at Level-0 and Level-1 data such as symbol level or channel noise, fading, etc. may be aggregated. In another example, at Level-2, packet level data may be aggregated (e.g., coupled with Level-1, sine UEs are scheduled at Level-2). In another example, at Level-3, packet level data may be aggregated (e.g., coupled with Level-1 and Level-2, since UEs can be in RRC Idle, Connected, or cell search mode).

In some designs, the extent to which data is aggregated at each network layer may depend on the level of heterogeneity of each respective network layer. Generally, more data needs to be aggregated per network layer if the network layer has a high degree (or high level) of heterogeneity (e.g., if the devices at a particular network layer are diverse in terms of capability, configuration, etc., then more data needs to be reported to the network component so the network component can make various decisions related to that network layer).

In some designs, a level of heterogeneity may be measured at each respective network layer (or level). Generally, as more data is aggregated for a particular network layer, that network layer is better defined and the level of heterogeneity decreases. As the level of heterogeneity decreases, the frequency of aggregation may be lowered, because the aggregation of such data consumes a high amount of resources.

Aspects of the disclosure are directed to conveying a data reporting instruction (e.g., a data aggregation instruction) for a network layer of a hierarchical network layer arrangement based on a level of heterogeneity associated with the network layer. Such aspects may provide various technical advantages, such as tailoring a level of data aggregation for a particular network layer based on its respective level of heterogeneity, while also sharing inter-layer heterogeneity data without consuming a high amount of resources (e.g., because reporting/aggregation for more homogeneous network layers may be reduced, etc.).

In an aspect, a method of operating a network component includes determining that a level of heterogeneity associated with a network layer of a hierarchical network layer arrangement with multiple network layers is above a threshold; transmitting, to at least one device associated with the network layer in response to the determination, a data reporting instruction associated with the network layer; and receiving data associated with the network layer from the at least one device in accordance with the data reporting instruction.

In an aspect, a method of operating a device includes computing a set of heterogeneity metrics associated with a network layer of a hierarchical network layer arrangement with multiple network layers, wherein the network layer includes the device and one or more other devices, wherein the set of level of heterogeneity metrics is indicative of a level of heterogeneity associated with the network layer being above a threshold; transmitting an indication of the set of heterogeneity metrics to a network component; receiving, a data reporting instruction associated with the network layer; collecting information associated with the device and the one or more other devices; and reporting data associated with the collected information to the network component in accordance with the data reporting instruction.

In an aspect, a network component includes a memory; at least one transceiver; and at least one processor communicatively coupled to the memory and the at least one transceiver, the at least one processor configured to: determine that a level of heterogeneity associated with a network layer of a hierarchical network layer arrangement with multiple network layers is above a threshold; transmit, via the at least one transceiver, to at least one device associated with the network layer in response to the determination, a data reporting instruction associated with the network layer; and receive, via the at least one transceiver, data associated with the network layer from the at least one device in accordance with the data reporting instruction.

In an aspect, a device includes a memory; at least one transceiver; and at least one processor communicatively coupled to the memory and the at least one transceiver, the at least one processor configured to: compute a set of heterogeneity metrics associated with a network layer of a hierarchical network layer arrangement with multiple network layers, wherein the network layer includes the device and one or more other devices, wherein the set of level of heterogeneity metrics is indicative of a level of heterogeneity associated with the network layer being above a threshold; transmit, via the at least one transceiver, an indication of the set of heterogeneity metrics to a network component; receive, via the at least one transceiver, a data reporting instruction associated with the network layer; collect information associated with the device and the one or more other devices; and report data associated with the collected information to the network component in accordance with the data reporting instruction.

In an aspect, a network component includes means for determining that a level of heterogeneity associated with a network layer of a hierarchical network layer arrangement with multiple network layers is above a threshold; means for transmitting, to at least one device associated with the network layer in response to the determination, a data reporting instruction associated with the network layer; and means for receiving data associated with the network layer from the at least one device in accordance with the data reporting instruction.

In an aspect, a device includes means for computing a set of heterogeneity metrics associated with a network layer of a hierarchical network layer arrangement with multiple network layers, wherein the network layer includes the device and one or more other devices, wherein the set of level of heterogeneity metrics is indicative of a level of heterogeneity associated with the network layer being above a threshold; means for transmitting an indication of the set of heterogeneity metrics to a network component; means for receiving, a data reporting instruction associated with the network layer; means for collecting information associated with the device and the one or more other devices; and means for reporting data associated with the collected information to the network component in accordance with the data reporting instruction.

In an aspect, a non-transitory computer-readable medium storing computer-executable instructions that, when executed by a network component, cause the network component to: determine that a level of heterogeneity associated with a network layer of a hierarchical network layer arrangement with multiple network layers is above a threshold; transmit, to at least one device associated with the network layer in response to the determination, a data reporting instruction associated with the network layer; and receive data associated with the network layer from the at least one device in accordance with the data reporting instruction.

In an aspect, a non-transitory computer-readable medium storing computer-executable instructions that, when executed by a device, cause the device to: compute a set of heterogeneity metrics associated with a network layer of a hierarchical network layer arrangement with multiple network layers, wherein the network layer includes the device and one or more other devices, wherein the set of level of heterogeneity metrics is indicative of a level of heterogeneity associated with the network layer being above a threshold; transmit an indication of the set of heterogeneity metrics to a network component; receive, a data reporting instruction associated with the network layer; collect information associated with the device and the one or more other devices; and report data associated with the collected information to the network component in accordance with the data reporting instruction.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A, 2B, and 2C illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4A illustrates an example of an integrated access and backhaul (IAB) network structure, according to aspects of the disclosure.

FIG. 4B is a diagram of an example IAB resource management framework, according to aspects of the disclosure.

FIG. 5 depicts a hierarchical network layer arrangement, in accordance with aspects of the disclosure.

FIG. 6 depicts a hierarchical network layer arrangement, in accordance with aspects of the disclosure.

FIG. 7 illustrates an exemplary process of communications, according to aspects of the disclosure.

FIG. 8 illustrates an exemplary process of communications, according to aspects of the disclosure.

FIG. 9 illustrates an example neural network, according to aspects of the disclosure.

FIG. 10 is a conceptual data flow diagram illustrating the data flow between different means/components in exemplary apparatuses in accordance with an aspect of the disclosure.

FIGS. 11-12 are diagrams illustrating examples of hardware implementations for apparatuses employing processing systems.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

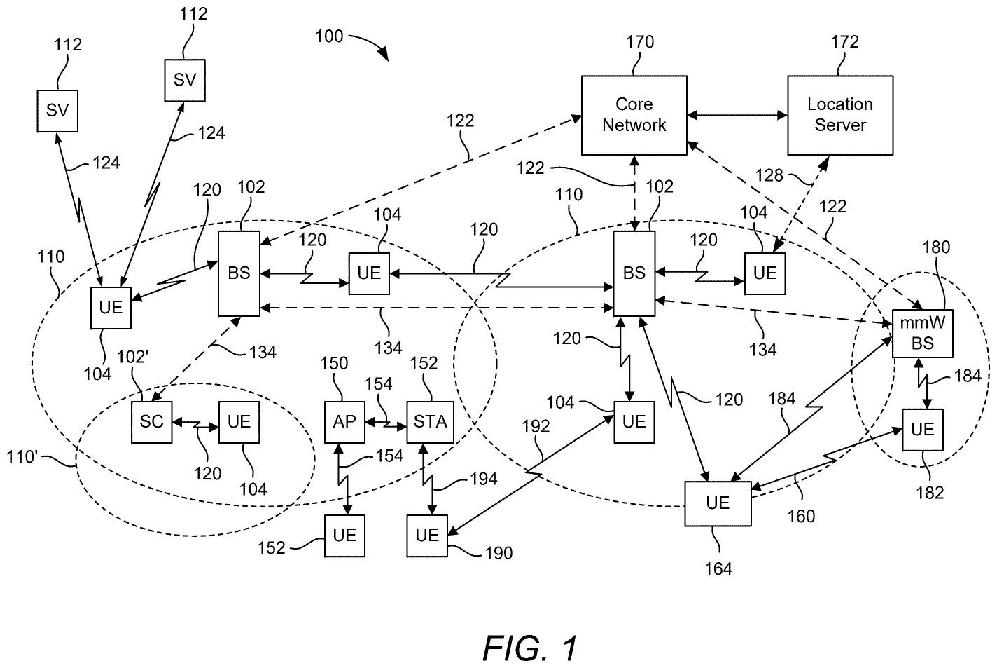

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHZ with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHz), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

In some cases, the UE 164 and the UE 182 may be capable of sidelink communication. Sidelink-capable UEs (SL-UEs) may communicate with base stations 102 over communication links 120 using the Uu interface (i.e., the air interface between a UE and a base station). SL-UEs (e.g., UE 164, UE 182) may also communicate directly with each other over a wireless sidelink 160 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, vehicle-to-vehicle (V2V) communication, vehicle-to-everything (V2X) communication (e.g., cellular V2X (cV2X) communication, enhanced V2X (eV2X) communication, etc.), emergency rescue applications, etc. One or more of a group of SL-UEs utilizing sidelink communications may be within the geographic coverage area 110 of a base station 102. Other SL-UEs in such a group may be outside the geographic coverage area 110 of a base station 102 or be otherwise unable to receive transmissions from a base station 102. In some cases, groups of SL-UEs communicating via sidelink communications may utilize a one-to-many (1:M) system in which each SL-UE transmits to every other SL-UE in the group. In some cases, a base station 102 facilitates the scheduling of resources for sidelink communications. In other cases, sidelink communications are carried out between SL-UEs without the involvement of a base station 102.

In an aspect, the sidelink 160 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs. In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Note that although FIG. 1 only illustrates two of the UEs as SL-UEs (i.e., UEs 164 and 182), any of the illustrated UEs may be SL-UEs. Further, although only UE 182 was described as being capable of beamforming, any of the illustrated UEs, including UE 164, may be capable of beamforming. Where SL-UEs are capable of beamforming, they may beamform towards each other (i.e., towards other SL-UEs), towards other UEs (e.g., UEs 104), towards base stations (e.g., base stations 102, 180, small cell 102′, access point 150), etc. Thus, in some cases, UEs 164 and 182 may utilize beamforming over sidelink 160.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on.

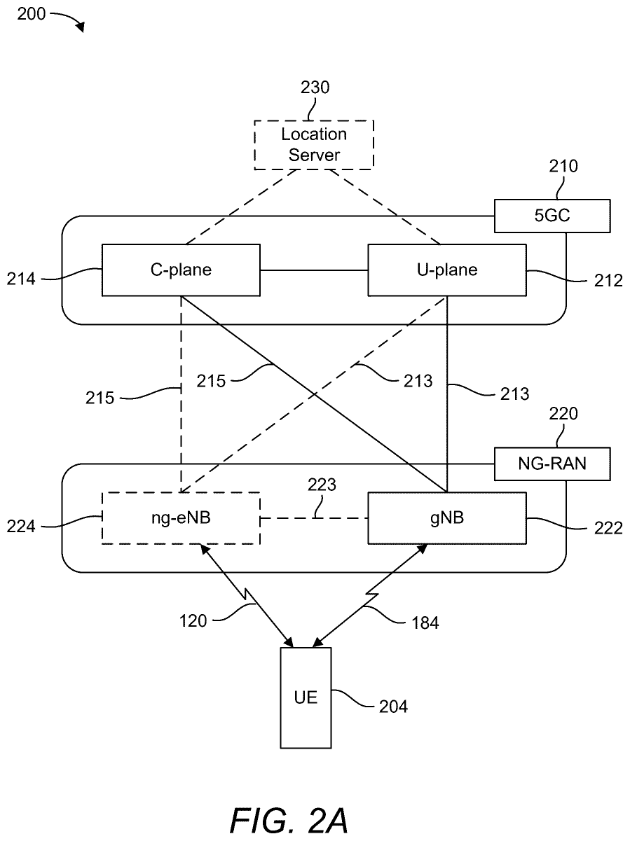

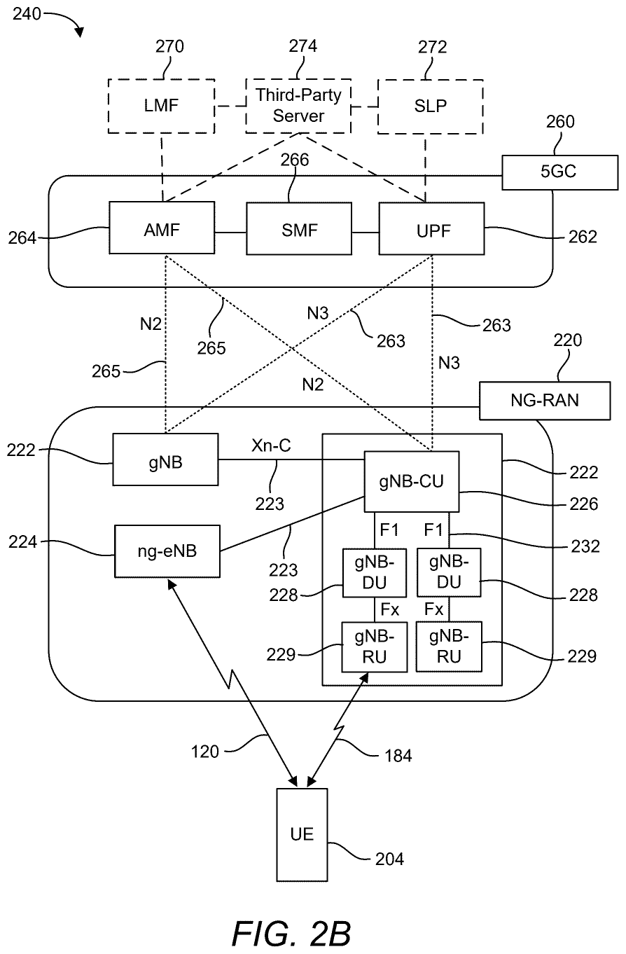

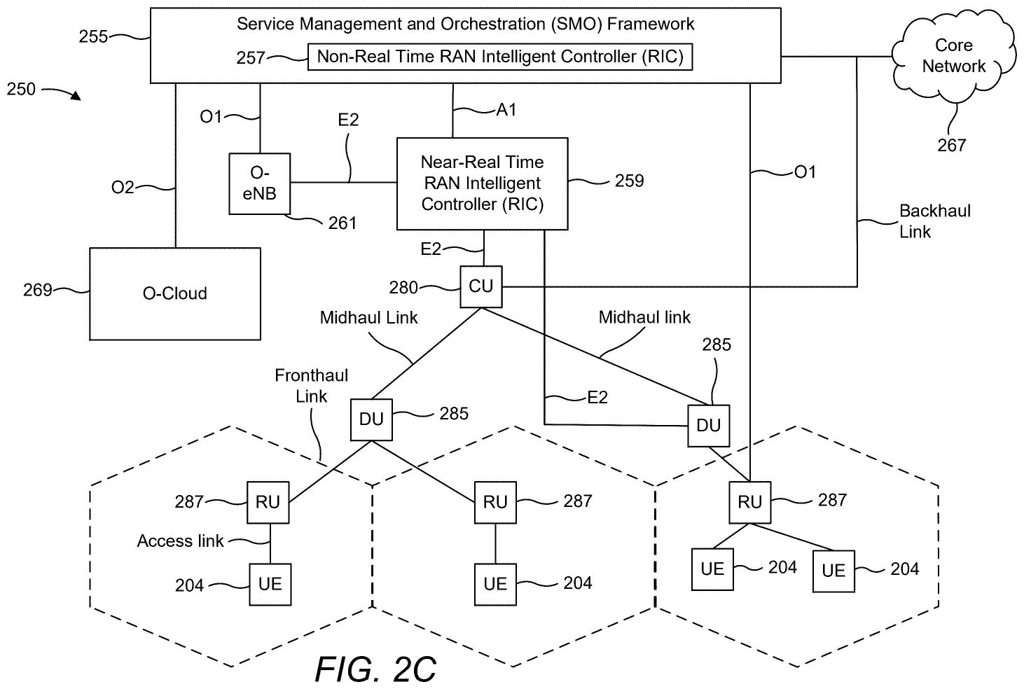

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 240. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP (Third Generation Partnership Project) access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QOS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station, or one or more units (or one or more components) performing base station functionality, may be implemented in an aggregated or disaggregated architecture. For example, a base station (such as a Node B (NB), evolved NB (eNB), NR base station, 5G NB, access point (AP), a transmit receive point (TRP), or a cell, etc.) may be implemented as an aggregated base station (also known as a standalone base station or a monolithic base station) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 2C illustrates an example disaggregated base station architecture 250, according to aspects of the disclosure. The disaggregated base station architecture 250 may include one or more central units (CUs) 280 (e.g., gNB-CU 226) that can communicate directly with a core network 267 (e.g., 5GC 210, 5GC 260) via a backhaul link, or indirectly with the core network 267 through one or more disaggregated base station units (such as a Near-Real Time (Near-RT) RAN Intelligent Controller (RIC) 259 via an E2 link, or a Non-Real Time (Non-RT) RIC 257 associated with a Service Management and Orchestration (SMO) Framework 255, or both). A CU 280 may communicate with one or more distributed units (DUs) 285 (e.g., gNB-DUs 228) via respective midhaul links, such as an F1 interface. The DUs 285 may communicate with one or more radio units (RUs) 287 (e.g., gNB-RUs 229) via respective fronthaul links. The RUs 287 may communicate with respective UEs 204 via one or more radio frequency (RF) access links. In some implementations, the UE 204 may be simultaneously served by multiple RUs 287.

Each of the units, i.e., the CUS 280, the DUs 285, the RUs 287, as well as the Near-RT RICs 259, the Non-RT RICs 257 and the SMO Framework 255, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 280 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 280. The CU 280 may be configured to handle user plane functionality (i.e., Central Unit-User Plane (CU-UP)), control plane functionality (i.e., Central Unit-Control Plane (CU-CP)), or a combination thereof. In some implementations, the CU 280 can be logically split into one or more CU-UP units and one or more CU-CP units. The CU-UP unit can communicate bidirectionally with the CU-CP unit via an interface, such as the E1 interface when implemented in an O-RAN configuration. The CU 280 can be implemented to communicate with the DU 285, as necessary, for network control and signaling.

The DU 285 may correspond to a logical unit that includes one or more base station functions to control the operation of one or more RUs 287. In some aspects, the DU 285 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 285 may further host one or more low PHY layers. Each layer (or module) can be implemented with an interface configured to communicate signals with other layers (and modules) hosted by the DU 285, or with the control functions hosted by the CU 280.

Lower-layer functionality can be implemented by one or more RUs 287. In some deployments, an RU 287, controlled by a DU 285, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 287 can be implemented to handle over the air (OTA) communication with one or more UEs 204. In some implementations, real-time and non-real-time aspects of control and user plane communication with the RU(s) 287 can be controlled by the corresponding DU 285. In some scenarios, this configuration can enable the DU(s) 285 and the CU 280 to be implemented in a cloud-based RAN architecture, such as a vRAN architecture.

The SMO Framework 255 may be configured to support RAN deployment and provisioning of non-virtualized and virtualized network elements. For non-virtualized network elements, the SMO Framework 255 may be configured to support the deployment of dedicated physical resources for RAN coverage requirements which may be managed via an operations and maintenance interface (such as an O1 interface). For virtualized network elements, the SMO Framework 255 may be configured to interact with a cloud computing platform (such as an open cloud (O-Cloud) 269) to perform network element life cycle management (such as to instantiate virtualized network elements) via a cloud computing platform interface (such as an 02 interface). Such virtualized network elements can include, but are not limited to, CUs 280, DUs 285, RUs 287 and Near-RT RICs 259. In some implementations, the SMO Framework 255 can communicate with a hardware aspect of a 4G RAN, such as an open eNB (O-eNB) 261, via an O1 interface. Additionally, in some implementations, the SMO Framework 255 can communicate directly with one or more RUs 287 via an O1 interface. The SMO Framework 255 also may include a Non-RT RIC 257 configured to support functionality of the SMO Framework 255.

The Non-RT RIC 257 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 259. The Non-RT RIC 257 may be coupled to or communicate with (such as via an A1 interface) the Near-RT RIC 259. The Near-RT RIC 259 may be configured to include a logical function that enables near-real-time control and optimization of RAN elements and resources via data collection and actions over an interface (such as via an E2 interface) connecting one or more CUs 280, one or more DUs 285, or both, as well as an O-eNB, with the Near-RT RIC 259.

In some implementations, to generate AI/ML models to be deployed in the Near-RT RIC 259, the Non-RT RIC 257 may receive parameters or external enrichment information from external servers. Such information may be utilized by the Near-RT RIC 259 and may be received at the SMO Framework 255 or the Non-RT RIC 257 from non-network data sources or from network functions. In some examples, the Non-RT RIC 257 or the Near-RT RIC 259 may be configured to tune RAN behavior or performance. For example, the Non-RT RIC 257 may monitor long-term trends and patterns for performance and employ AI/ML models to perform corrective actions through the SMO Framework 255 (such as reconfiguration via O1) or via creation of RAN management policies (such as A1 policies).

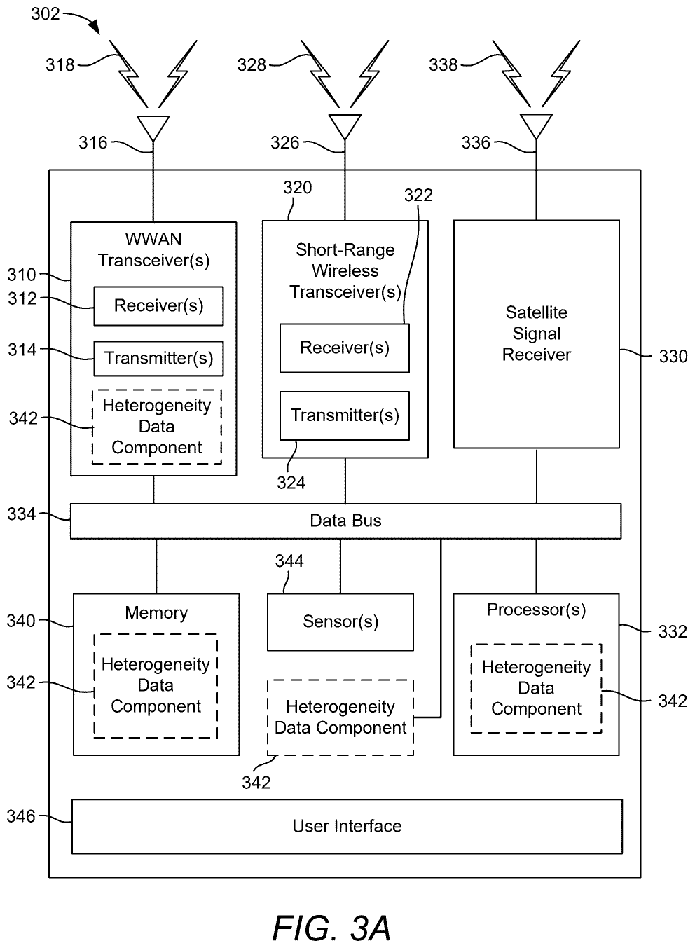

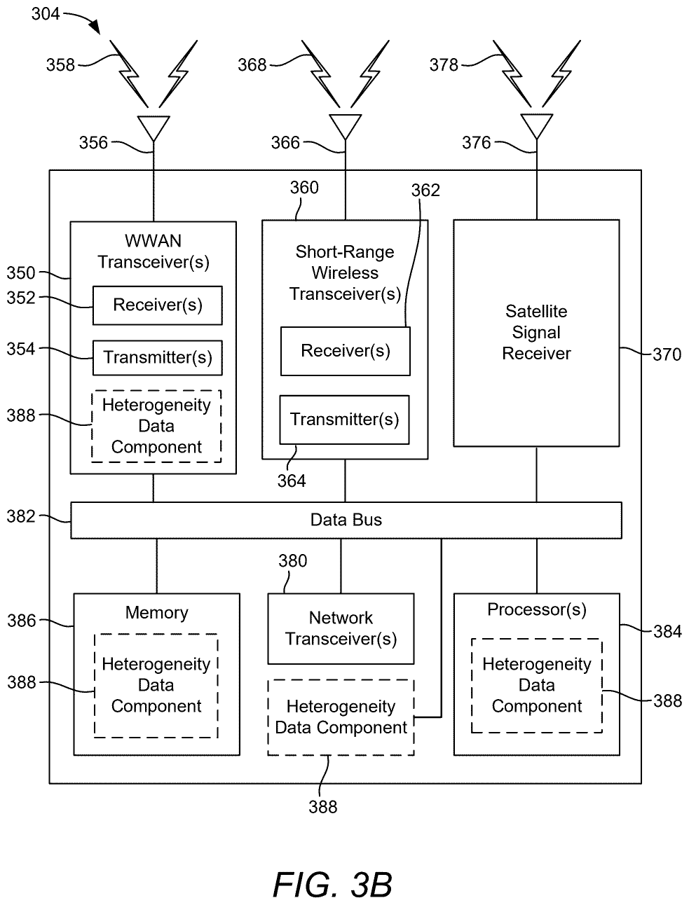

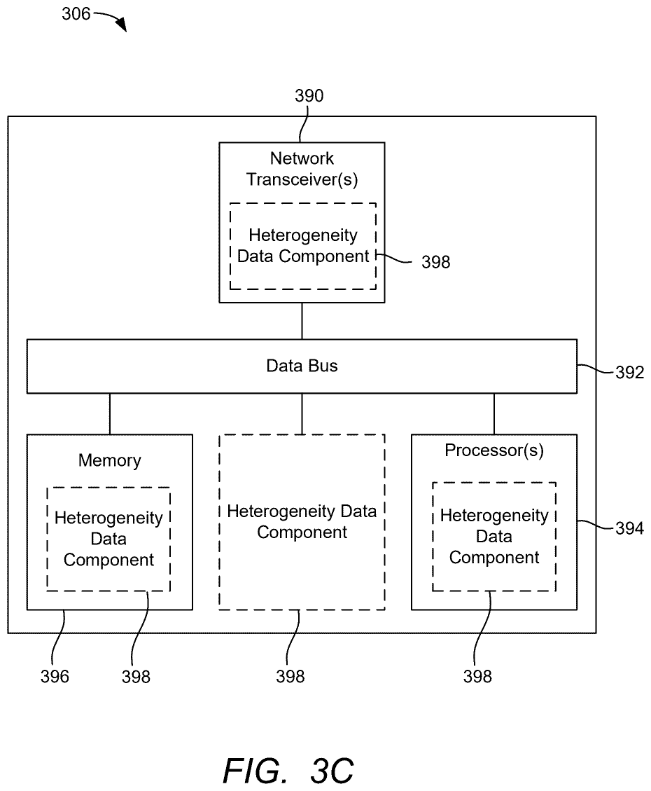

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the file transmission operations as taught herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., WiFi, LTE-D, Bluetooth®, Zigbee®, Z-Wave®, PC5, dedicated short-range communications (DSRC), wireless access for vehicular environments (WAVE), near-field communication (NFC), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be WiFi transceivers, Bluetooth® transceivers, Zigbee® and/or Z-Wave® transceivers, NFC transceivers, or vehicle-to-vehicle (V2V) and/or vehicle-to-everything (V2X) transceivers.

The UE 302 and the base station 304 also include, at least in some cases, satellite signal receivers 330 and 370. The satellite signal receivers 330 and 370 may be connected to one or more antennas 336 and 376, respectively, and may provide means for receiving and/or measuring satellite positioning/communication signals 338 and 378, respectively. Where the satellite signal receivers 330 and 370 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. Where the satellite signal receivers 330 and 370 are non-terrestrial network (NTN) receivers, the satellite positioning/communication signals 338 and 378 may be communication signals (e.g., carrying control and/or user data) originating from a 5G network. The satellite signal receivers 330 and 370 may comprise any suitable hardware and/or software for receiving and processing satellite positioning/communication signals 338 and 378, respectively. The satellite signal receivers 330 and 370 may request information and operations as appropriate from the other systems, and, at least in some cases, perform calculations to determine locations of the UE 302 and the base station 304, respectively, using measurements obtained by any suitable satellite positioning system algorithm.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 332, 384, and 394, respectively, for providing functionality relating to, for example, wireless communication, and for providing other processing functionality. The processors 332, 384, and 394 may therefore provide means for processing, such as means for determining, means for calculating, means for receiving, means for transmitting, means for indicating, etc. In an aspect, the processors 332, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include heterogeneity data component 342, 388, and 398, respectively. The heterogeneity data component 342, 388, and 398 may be hardware circuits that are part of or coupled to the processors 332, 384, and 394, respectively, that, when executed, cause the UE 302, the base station 304, and the network entity 306 to perform the functionality described herein. In other aspects, the heterogeneity data component 342, 388, and 398 may be external to the processors 332, 384, and 394 (e.g., part of a modem processing system, integrated with another processing system, etc.). Alternatively, the heterogeneity data component 342, 388, and 398 may be memory modules stored in the memories 340, 386, and 396, respectively, that, when executed by the processors 332, 384, and 394 (or a modem processing system, another processing system, etc.), cause the UE 302, the base station 304, and the network entity 306 to perform the functionality described herein. FIG. 3A illustrates possible locations of the heterogeneity data component 342, which may be, for example, part of the one or more WWAN transceivers 310, the memory 340, the one or more processors 332, or any combination thereof, or may be a standalone component. FIG. 3B illustrates possible locations of the heterogeneity data component 388, which may be, for example, part of the one or more WWAN transceivers 350, the memory 386, the one or more processors 384, or any combination thereof, or may be a standalone component. FIG. 3C illustrates possible locations of the heterogeneity data component 398, which may be, for example, part of the one or more network transceivers 390, the memory 396, the one or more processors 394, or any combination thereof, or may be a standalone component.

The UE 302 may include one or more sensors 344 coupled to the one or more processors 332 to provide means for sensing or detecting movement and/or orientation information that is independent of motion data derived from signals received by the one or more WWAN transceivers 310, the one or more short-range wireless transceivers 320, and/or the satellite signal receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 332. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 332, which implements Layer-3 (L3) and Layer-2 (L2) functionality.

In the uplink, the one or more processors 332 provides demultiplexing between transport and logical channels, packet reassembly, deciphering, header decompression, and control signal processing to recover IP packets from the core network. The one or more processors 332 are also responsible for error detection.

Similar to the functionality described in connection with the downlink transmission by the base station 304, the one or more processors 332 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or PC or laptop may have Wi-Fi and/or Bluetooth capability without cellular capability), or may omit the short-range wireless transceiver(s) 320 (e.g., cellular-only, etc.), or may omit the satellite signal receiver 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite receiver 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 334, 382, and 392, respectively. In an aspect, the data buses 334, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 334, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 332, 384, 394, the transceivers 310, 320, 350, and 360, the memories 340, 386, and 396, the heterogeneity data component 342, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as WiFi).

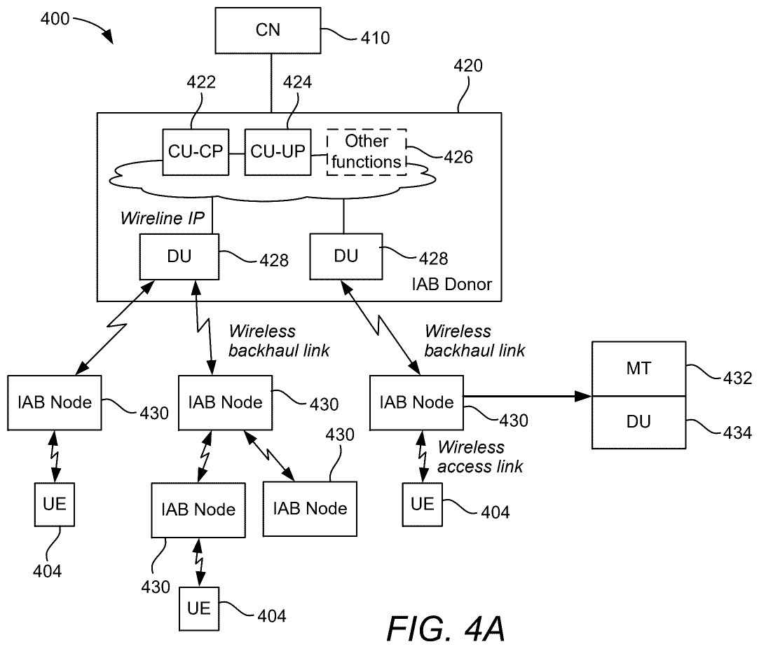

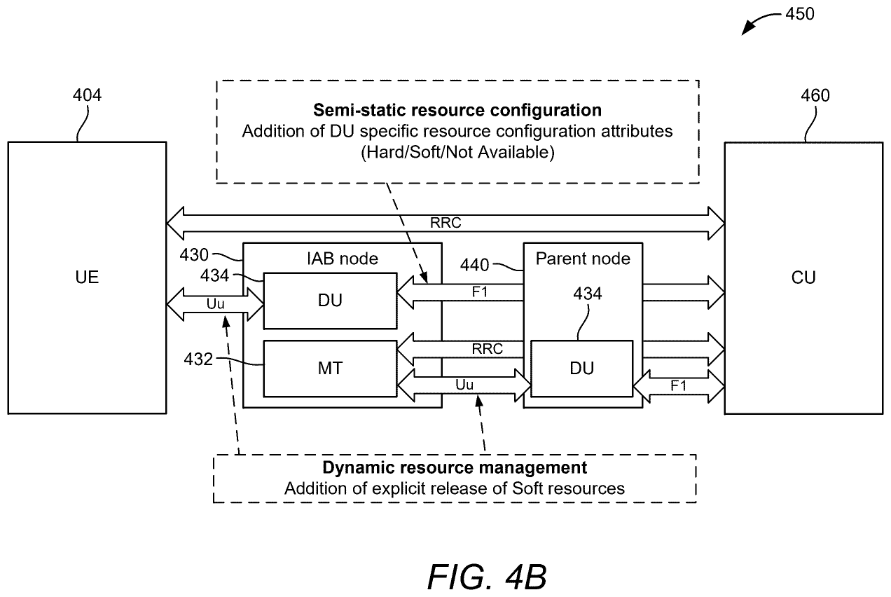

FIG. 4A illustrates an example of an IAB network structure 400, according to aspects of the disclosure. The IAB network structure 400 includes a core network (CN) 410 (e.g., 5GC 210 or 260) and at least one IAB donor 420. The IAB donor 420 may be an NG-RAN node (e.g., a gNB or other network entity in the NG-RAN 220) that provides a same interface to the core network 410 as other non-IAB NG-RAN nodes (e.g. gNBs) and provides wireless backhaul functionality to downstream IAB nodes 430. The IAB donor 420 includes a central unit control plane (CU-CP) function 422, a central unit user plane (CU-UP) function 424, and other optional functions 426. These various functions are connected to one or more distributed units (DUs), also referred to as IAB donor-DUs 428 (two in the example of FIG. 4A) over wireline IP links. The DUs 428 of the IAB donor 420 support NR wireless backhaul access to one or more IAB nodes 430 using an RF interface that is typically a subset of the NR interface supported by a gNB-DU to support access by a UE. The links between the DUs 428 and the IAB nodes 430 provide backhaul connectivity over a wireless link, and thus, as shown in FIG. 4A, are referred to as “wireless backhaul links.”

An IAB node 430 includes a DU 434 (also referred to as an IAB-DU 434) that supports NR radio access from child nodes (e.g., UEs 404 and/or other IAB nodes 430) in the same way as that supported by a gNB-DU or IAB donor-DU. The IAB node 430 also includes a mobile termination (MT) 432 that accesses its parent node using NR (e.g., accesses the DU 434 of another IAB node 430 or a DU 428 of the IAB donor 420). The DU 434 of an IAB node 430 may support one or more cells of its own and appears as a normal base station to UEs 404 (e.g., any of the UEs described herein) and/or appears as an IAB donor-DU to the MTs 432 of other IAB nodes 430 connecting to it. The links between the DU 434 of a parent IAB node 430 and its child nodes (e.g., UEs 404 and/or the MTs 432 of other IAB nodes 430) provide network access over a wireless link, and thus, as shown in FIG. 4A, are referred to as “wireless access links.” Referring to FIG. 1, the small cell base station 102′ may be an IAB node 430 and the macro cell base station 102 to which it is connected may be an IAB donor 420.

Connecting an IAB node 430 to the network may use the same initial access mechanism (e.g., a random-access procedure) as a UE 404. Once connected, an IAB node 430 receives necessary configuration data from the IAB donor 420. Additional child IAB nodes 430 can connect to the network through the cell(s) created by a parent IAB node 430, thereby enabling multi-hop wireless backhauling.

FIG. 4B is a diagram of an example IAB resource management framework 450, according to aspects of the disclosure. FIG. 4B illustrates a CU 460 belonging to an IAB donor (not shown in FIG. 4B), a parent node 440, an IAB node 430, and a UE 404. The CU 460 may correspond to one or both of the CU-CP 422 and CU-UP 424 in FIG. 4A. The parent node 440 may be any IAB node 430 having a child IAB node 430. The IAB node 430 includes a DU 434 and an MT 432. The parent node 440 also includes a DU 434 and an MT 432, but for simplicity, only the DU 434 is shown.

The CU 460 is a logical node that includes the base station functions of transferring user data, mobility control, radio access network sharing, positioning, session management, and the like, except for those functions allocated exclusively to the DU(s) 428 (not shown in FIG. 4B). More specifically, the CU 460 intercepts and supports the radio resource control (RRC) and packet data convergence protocol (PDCP) layers of a base station, while the DU(s) 428 intercepts and supports the radio link control (RLC), medium access control (MAC), and physical (PHY) layers of the base station. Thus, as shown in FIG. 4B, the UE 404 and the CU 460 communicate at a control plane level via a radio resource control (RRC) protocol layer, whereas the UE 404 and the DU 434 of the IAB node 930 communicate over the Uu interface (the air interface between a UE and a base station).

Because the IAB node 430 (specifically, the MT 432) acts similar to a UE in its interaction with the parent node 440 (specifically, the DU 434), the MT 432 of the IAB node 430 can also communicate with the CU 460 via the RRC layer and with the DU 434 of the parent node 440 over the Uu interface (because the link between the IAB node 430 and its parent node 440 is a wireless backhaul link). However, the respective DUs 434 of the IAB node 430 and parent node 440 communicate with the CU 460 over a wireless front-haul interface referred to as the “F1-AP” or “F1” interface. The DUs 434 obtain an IP address for F1-C (F1 control plane) and F1-U (F1 user plane) traffic from the CU 460. Any F1 traffic (F1-C and F1-U) from the DU 434 of an IAB node 430 terminates at the CU 460.

In the IAB resource management framework 450, resource and slot format definitions remain compatible with legacy UEs (e.g., non-NR UEs or older NR UEs). The focus is on the half-duplex constraint and time division multiplexing (TDM) operation between the DU 434 and the MT 432. Another difference is that additional resource attributes are defined for, and visible to, the DU 434 for semi-static resource configuration. Specifically, the additional attributes include Hard, Soft, and Not Available designations. A “Hard” designation indicates that the resource can be assumed to be used by the DU 434. A “Not Available” designation indicates that the resource cannot be used by the DU 434 (e.g., with some exceptions for cell-specific signals). A “Soft” designation indicates that by default the resource cannot be used by the DU 434. Rather, it can be assumed to be used only if (a) the parent node 440 explicitly releases it, or (b) if the IAB node 430 can determine that it does not impact the operation of its MT 432. Thus, as shown in FIG. 4B, the dynamic resource management between the IAB node 430 and the UE 404 includes the additional functionality/signaling of explicit releases for Soft resources received by an MT 432 from its parent DU 434. In some designs, Soft resources of an IAB node are dynamically controlled by its parent node (e.g., explicit indication via DCI 2_5, or implicit indication without impact to an MT 432).

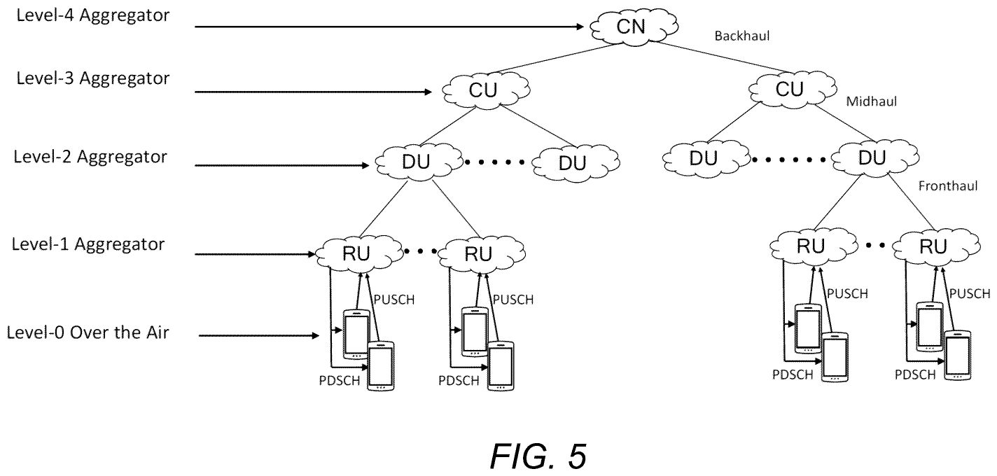

FIG. 5 depicts a hierarchical network layer arrangement 500, in accordance with aspects of the disclosure. The hierarchical network layer arrangement 500 includes components that are described above, such as UEs, Rus, DUs, CUs and a core network (CN). In FIG. 5, the various components of the hierarchical network layer arrangement 500 are arranged in rows. Each row depicted in FIG. 5 may interchangeable be characterized herein as a network level or network layer. Generally, each network layer may be characterized based on a grouping of similar device types (e.g., similar in terms of device-type such as UE/RU/DU/CU/CN/etc., similar in terms of data that is measured, received and/or processed, or a combination thereof). In FIG. 5, the network layers are denoted as Level-0 (e.g., an OTA layer that includes the UEs served by the network), Level-1 (e.g., RU layer), Level 2 (e.g., DU layer), Level 3 (e.g., CU layer) and Level-4 (e.g., CN layer).

With respect to FIG. 5, in some designs, various data can be aggregated across multiple devices at each respective network layer for analysis at a network component (e.g., CU, CN, etc.). In the context of data for wireless communications, for example, at Level-0 and Level-1 data such as symbol level information or UE level information such as channel observations or derivative parameters etc. may be aggregated. In another example, at Level-2, packet level data may be aggregated (e.g., coupled with Level-1, since UEs are scheduled at Level-2). In another example, at Level-3, packet level data may be aggregated (e.g., coupled with Level-1 and Level-2, since UEs can be in RRC Idle, Connected, or cell search mode).

In general, application-level data from UEs connected to different layers of the network may be aggregated. For example, for UEs collecting images (as data packets), some feature aggregation may have within the UEs connected to the RU, additional aggregation to all the UEs in all the RUs connected to a DU, etc.

In some designs, the extent to which data is aggregated at each network layer may depend on the level of heterogeneity of each respective network layer. In an aspect, the level of heterogeneity for a network layer can be considered as reflecting a distribution of the data that is available at the respective network layer. Consider an example where channel observations from UEs are used for training a neural network (NN). The channel observations reflect the environment in which the UEs are located. UEs which are associated with a given RU may experience similar channel conditions as the UEs are physically located in a contained space (or coverage area) which is served by the RU, and thus exhibit lower heterogeneity than UEs served by different RUs. Channel observations from UEs associated with a different RUs may experience a higher degree of variation (and thus higher heterogeneity) than channel observations from UEs associated with the same RU. Similarly, channel observations from UEs associated with different DUs may have substantially different profiles (and higher heterogeneity) as the RUs associated with the DUs may be in completely different regions. Similarly, observations can be made for channel variation at other layers in a cellular network. In other words, UEs belonging to one RU may experience lower heterogeneity (higher homogeneity or similarity) as compared to UEs belonging to one DU which may be associated with multiple RUs.

In some designs, the level of heterogeneity also depends on the coverage of each network layer. For example, indoor UEs associated with an indoor RU may have a different level of heterogeneity than outdoor UEs due to the large variation of channel indoors due to rich features in the environment. On the other hand, an outdoor RU (e.g., associated with a microcell rather than a small cell) may serve a much larger number of UEs due to the nature of cellular deployment and by virtue of covering a larger area, the UEs may experience significantly different channel conditions.

While various examples of levels of heterogeneity of a UE network layer (e.g., a network layer that comprises UEs, or a network layer that defined based on the type of data expected to be visible to or measurable by UEs generally or a particular class of UE) are provided above with respect to channel observations for the UEs, this concept can be readily extended to any data type that is collected by the UEs that can be used for training neural networks. In this manner, data collected by UEs can be used as training data to develop a model that can then be used by other UEs (i.e., for a network layer that comprises UEs). Another example could be images collected by a UE. For example, a UE in close proximity to another UE (i.e. associated to the same RU) may collect similar images as the environment may have some common elements (e.g., environmental objects, lighting conditions, etc.) to both the UEs, while a UE associated with a different DU may collect very different images by virtue of being physically located in a different environment. In this manner, data collected by UEs of a particular DU can be used as training data to develop a model that can then be used by other UEs (i.e., for a network layer that comprises UEs of that particular DU).

In some designs, knowledge of heterogeneity level may be used for training neural networks associated with various network layers. For example, a neural network may be trained for an RU-centric network layer so as to specialize in RU-specific variations, while other neural networks may be trained based on data from multiple network layers to handle data due to DU-specific or CU-specific variations (e.g., as the amount of variation for data collected at the DU and CU would be larger than at RU). In this manner, data collected by RUs can be used as training data to develop a model that can then be used by other RUs, DUs can be used as training data to develop a model that can then be used by other DUs, CUs can be used as training data to develop a model that can then be used by other CUs, CNs can be used as training data to develop a model that can then be used by other CNs, and so on.

In some designs, the level of heterogeneity in the data to accomplish a specific neural network training task is application-specific. For example, some applications may benefit from a large heterogeneity in the data (distribution over a wide variety of examples) at a given network layer in the cellular network, while some applications may work suitably with a smaller heterogeneity at a given network layer in the cellular network. In some designs, if there is a mismatch in the expected level of heterogeneity, then the neural network may not train well or adapt well to a given environment. Hence, a mechanism to measure the heterogeneity of data at each network layer in the cellular network can be utilized to help determine whether the data is to be aggregated from other entities (e.g., in same network layer or other network layers) before neural network training is performed.

One example of measuring a heterogeneity of data is using a compressed representation or an embedding of the data into a lower dimensional subspace and measuring the distance between two data points at the lower dimensions. There are several methods available in machine learning and statistics literature to determine a compact representation/embedding of the data. For example, mechanisms such as principal component analysis, independent component analysis, T-distributed Stochastic Neighbor Embedding (t-SNE), autoencoder based latent space representations, etc., can be used to determine a lower dimensional representation of the data. Using such a lower dimensional representation of the data, one can obtain a distance between 2 different observations using metrics such as Weighted Euclidean distance, KL divergence etc. The (ex. 2D Euclidean or other similar metrics) can be used to determine the distance. The level of heterogeneity of a given dataset can be determined based on the distribution of this distance (or alternatively, a minimum, maximum, mean value, median value, etc., of this distance metric).

In one specific and non-limiting example, to measure the statistical heterogeneity among different device domains, the “angle” between client data subspaces spanned by the most significant left singular vectors of client data may be evaluated. For a dataset, D, the data of each class Ci is placed in the columns of its corresponding matrix Qᵢ. Note that truncated Singular Value Decomposition (SVD) of a real m×n matrix M is a factorization of the form \tilde{M}=UₚΣₚV^{T} where Uₚ=[u₁, u₂, . . . , uₚ] is an m×p orthonormal matrix, Σₚ is a p×p rectangular diagonal matrix with non-negative real numbers on the main diagonal, and Vₚ=[v₁, v₂, . . . , vₚ] is a p×n orthonormal matrix, where uᵢ ∈ Uₚ and vᵢ ∈ Vₚ are the left and right singular vectors, respectively. With this in mind, truncated SVD on Qᵢ and obtain Uⁱ=[u₁, u₂, . . . , uₚ], (p<<rank (Dₖ)). These Uₚs span the class subspace and provide a useful signature for distinguishing the underlying distributions of each class in D because these principal bases characterize the main trends in the data of clients (like eigenfaces). Then according to the principal angle in between of the class subspaces, how similar/dissimilar (or homogeneous/heterogeneous) two classes can be determined based on which generate Non-independent and identically distributed (IID or i.i.d) data partitioning can be generated. Generally, the more orthogonal two subspaces are the more heterogeneous the data of two classes will be.

Having the data signature of all classes of dataset D, in hand, a proximity matrix A can be obtained, either as in Eq. (1) whose entries are the smallest principle angle between the pairs of Uⁱ or as in Eq. (2) whose entries are the summation over the angle in between of the corresponding u vectors (in identical order) in each pairs of Uⁱ (where tr (.) is the trace operator).

$$\begin{matrix}{A}_{i , j} = {Θ}_{1} ( {U}_{p}^{i} , {U}_{p}^{j} ) , & i , j = 1 , … , \vert C \vert\end{matrix} \qquad Eq . ( 1 )$$

$$\begin{matrix}{A}_{i , j} = t r ( arc cos ( {U}_{p}^{i} * {U}_{p}^{j} ) ) , & i , j = 1 , … , \vert C \vert\end{matrix} \qquad Eq . ( 2 )$$

where C is the total number of classes of D. Either of Eq. 1 and Eq. 2 can be employed in practice, however, theoretically Eq. 2 is more rigorous. Now, in order to capture the similarity/dissimilarity of different classes of D, disjoint clusters of classes may be formed. For forming disjoint clusters, agglomerative hierarchical clustering can be performed on the proximity matrix A. In some aspects, the best number of clusters can easily be determined just by analyzing the proximity matrix. Each cluster contain classes which are roughly identically distributed.

Generally, more data needs to be aggregated per network layer if the network layer has a low degree of heterogeneity. Each UE or each network entity such as a RU or a DU or a CU may be configured to measure the heterogeneity of the data (e.g., see examples above) and report it to the higher layers. For example, a UE may report the heterogeneity of data to one or more levels above (ex. RU or DU) and an RU may provide this information to the DU or CU, etc., for determining a dataset aggregation strategy for training.

With respect to FIG. 5, in some designs, data may be aggregated across the respective network layers in an iterative manner, e.g.:

```
for a given CN:
  for each CU:
    for each DU:
      for each RU or OTA:
          for each UE:
            update parameters
        Level-1 aggregation
Level-2 aggregation
    Level-3 aggregation
Level-4 aggregation
```

In some designs, a level of heterogeneity may be measured at each respective network layer (or level). Generally, as more data is aggregated for a particular network layer, that network layer is better defined and the level of heterogeneity decreases. As the level of heterogeneity decreases, the frequency of aggregation may be lowered, because the aggregation of such data consumes a high amount of resources.

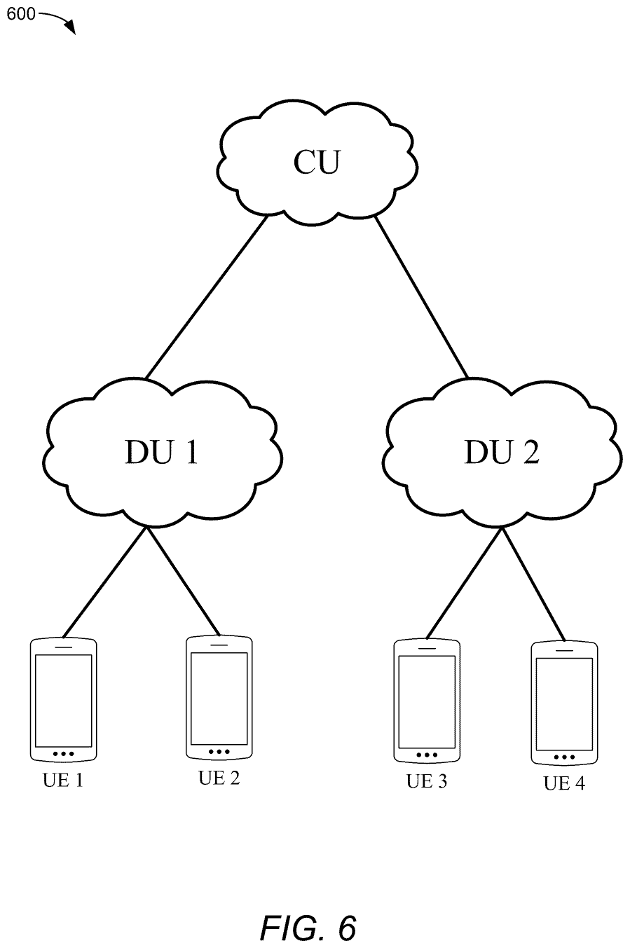

FIG. 6 depicts a hierarchical network layer arrangement 600, in accordance with aspects of the disclosure. The hierarchical network layer arrangement 600 is a simplified version of the hierarchical network layer arrangement 500 of FIG. 5. The hierarchical network layer arrangement 600 includes a CU, DUs 1 and 2, and UEs 1, 2, 3 and 4. In the hierarchical network layer arrangement 600, the CN layer (e.g., Level-4) is omitted for simplicity, and the RU layer (e.g., Level-1) is also omitted (e.g., functionally, the RU layer may be made part of the DU layer in FIG. 6).

Referring to FIG. 6, in some designs with respect to an identically distributed (i.i.d) use case, assume all UEs have the same amount of i.i.d. data and include training samples for all classes such that UE1, UE2, UE3 and UE4 have samples for class {0, 1, 2, . . . , 9}. Generally, higher levels of non-i.i.d data is correlated with a lower level of homogeneity, while higher levels of i.i.d data is correlated with a higher level of homogeneity. For each communication round t, assume that each UE updates parameters for e=1, 2, . . . , E (where E is the minimum number of epochs for which a machine learning algorithm is executed at each layer before a next round of communication takes place where new data is received). In some designs, aggregation is triggered at CU layer if t&E==0. In some designs, at aggregation is triggered at DU layer if t&E==0. In some designs, aggregation is triggered at DU layer if t&E==0 and/or at CU layer if t&nE==0, whereby n>1.

Referring to FIG. 6, in some designs with respect to non-i.i.d use case, assume all UEs have the same amount of non-i.i.d. data such that UE1 has samples only for even numbered classes {0, 2, 4, 6, 8}, UE2 has samples only for odd numbered classes {1, 3, 5, 7, 9}, UE3 has samples only for the first 5 classes {0, 1, 2, 3, 4}, UE4 has samples only for the last 5 classes {5, 6, 7, 8, 9}. In an example, the classes {0, 1, 2, . . . , 9} (MNIST dataset) may represent a dataset of handwritten images. In some designs, at each communication round t, assume that each UE updates parameters for e=1, 2, . . . , E. In some designs, aggregation is triggered at CU layer if t&E==0. In some designs, at aggregation is triggered at DU layer if t&E==0. In some designs, aggregation is triggered at DU layer if t&E==0 and/or at CU layer if t&nE==0, whereby n>1.

Aspects of the disclosure are directed to conveying a data reporting instruction (e.g., a data aggregation instruction) for a network layer of a hierarchical network layer arrangement based on a level of heterogeneity associated with the network layer. Such aspects may provide various technical advantages, such as tailoring a level of data aggregation for a particular network layer based on its respective level of heterogeneity, while also sharing inter-layer heterogeneity data without consuming a high amount of resources (e.g., because reporting/aggregation for more homogeneous network layers may be reduced, etc.).

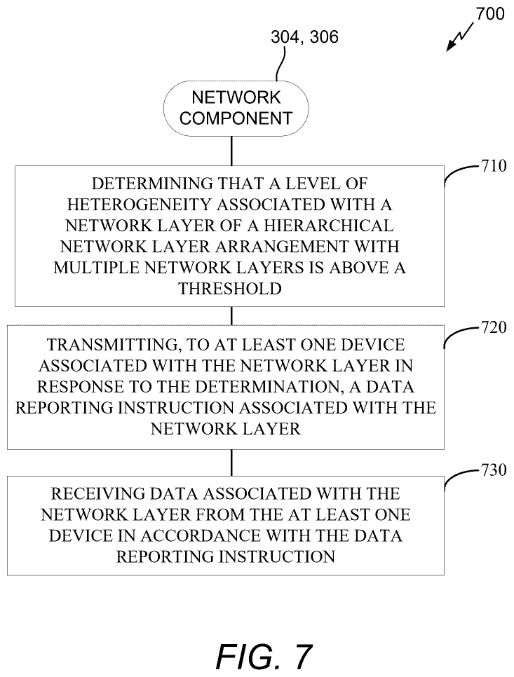

FIG. 7 illustrates an exemplary process 700 of communications, according to aspects of the disclosure. The process 700 of FIG. 7 is performed by a network component (e.g., UE BS 304 or network entity 306, such as RU 229 or DU 228 or CU 226 or third party server 274, etc.).

Referring to FIG. 7, at 710, the network component (e.g., processor (ss) 332 or 384 or 394, heterogeneity data component 342 or 388 or 398, etc.) determines a level of heterogeneity associated with a network layer of a hierarchical network layer arrangement with multiple network layers is above a threshold. The determination at 710 may occur in various ways. In some designs, the determined level of heterogeneity of 710 is binary or Boolean in the sense that one or more conditions among devices of that network layer are dissimilar for the level of heterogeneity to exceed the threshold (e.g., if any of the one or more conditions is similar across a threshold proportion of devices of that network layer, then the threshold is not exceeded, or if any of the one or more conditions is dissimilar across a threshold proportion of devices of that network layer, then the threshold is exceeded). In other designs, the determined level of heterogeneity of 710 may be a computed score (e.g., a set of conditions are evaluated across devices in that network layer, and a weighted or non-weighted sum of the matching (similar) or non-matching (dissimilar) conditions across the devices in that network layer is computed as the score). For example, the heterogeneity level determination may be based upon a pre-configuration of the network layer. In other designs, the heterogeneity level determination may be based upon a set of heterogeneity metrics received from one or more devices associated with the network layer. For example, as noted above, the level of heterogeneity indicates a degree of dissimilarity of a distribution of data that is available or measurable at a set of devices associated with the network layer.

Referring to FIG. 7, at 720, the network component (e.g., transmitter(s) 314 or 324 or 354 or 364, network transceiver(s) 380 or 390, etc.) transmits, to at least one device associated with the network layer in response to the determination, a data reporting instruction associated with the network layer. The transmission of 720 may occur in various ways based on the network layer associated with the network component and the network layer associated with the at least one device. For example, the at least one device may correspond to a UE which may be instructed to collect (e.g., aggregate) data at OTA layer via sidelink, and report some part of that data back to the CN layer, or the at least one device may correspond to RU or DU or CU which may be instructed to collect (e.g., aggregate) backhaul, midhaul and/or fronthaul data via wired communication, and report some part of that data back to the CN layer.

Referring to FIG. 7, at 730, the network component (e.g., receiver(s) 312 or 322 or 352 or 362, network transceiver(s) 380 or 390, etc.) receives data associated with the network layer from the at least one device in accordance with the data reporting instruction. In some designs, the data from the at least one device may include gradients between parameters or measurements at two or more devices associated with the network layer. As noted above for UE-centric network layer as an example, these parameters or measurements may include channel conditions, captured images, and so on. In this case, the gradients may include differentials between measured channel impulse responses, or differentials between captured images (e.g., which may be defined as a number, such as L1-norm or Manhattan distance, or L2-norm or Euclidean distance). In some designs, in scenario where the at least one device correspond to at least one UE, the data from the at least one device is associated with gradients between radio frequency (RF) fingerprints (e.g., each RF fingerprint can be quantized, with a differential taken between the two quantized values, etc.) at two or more UEs (e.g., determined via sidelink communication between the UEs).

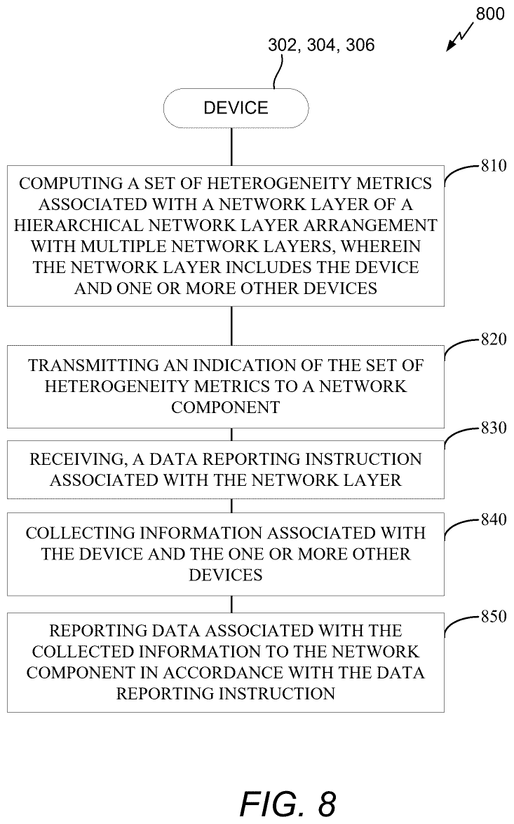

FIG. 8 illustrates an exemplary process 800 of communications, according to aspects of the disclosure. The process 800 of FIG. 8 is performed by a device (e.g., UE 302 or BS 304 or network entity 306, such as RU 229 or DU 228 or CU 226, etc.)

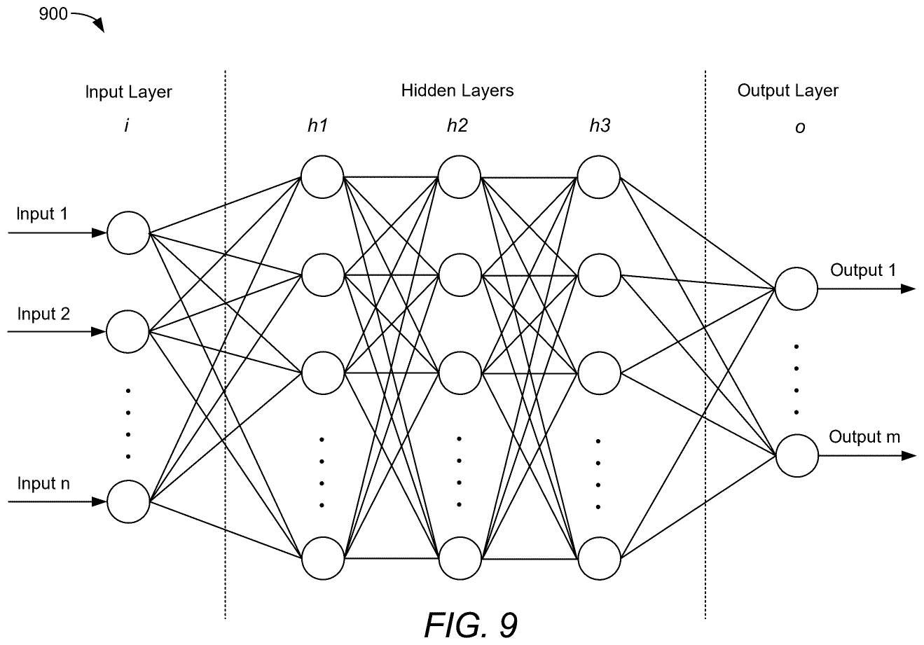

Referring to FIG. 8, at 810, the device (e.g., processor (ss) 332 or 384 or 394, heterogeneity data component 342 or 388 or 398, etc.) computes a set of heterogeneity metrics associated with a network layer of a hierarchical network layer arrangement with multiple network layers, wherein the network layer includes the device and one or more other devices, wherein the set of level of heterogeneity metrics is indicative of a level of heterogeneity associated with the network layer being above a threshold. In some designs, a computation rule for computing the set of heterogeneity metrics at the device is pre-defined. In other designs, the computation rule for computing the set of heterogeneity metrics at the device is signaled to the device by the network component. In some designs, the computation rule includes a neural network (NN), which is described in more detail below with respect to FIG. 9. For example, as noted above, the level of heterogeneity indicates a degree of dissimilarity of a distribution of data that is available or measurable at a set of devices associated with the network layer.

Referring to FIG. 8, at 820, the device (e.g., transmitter(s) 314 or 324 or 354 or 364, network transceiver(s) 380 or 390, etc.) transmits an indication of the set of heterogeneity metrics to a network component. In some designs, the indication at 820 may at least in part facilitate the heterogeneity level determination by the network component at 710 of FIG. 7. In other designs, as noted above, the heterogeneity level determination may instead be based upon a pre-configuration of the network layer.

Referring to FIG. 8, at 830, the device (e.g., receiver(s) 312 or 322 or 352 or 362, network transceiver(s) 380 or 390, etc.) receives data reporting instruction associated with the network layer. The reception of 830 may occur in various ways based on the network layer associated with the network component and the network layer associated with the device. For example, the device may correspond to a UE which may be instructed to collect (e.g., aggregate) data at OTA layer via sidelink, and report some part of that data back to the CN layer, or the device may correspond to RU or DU or CU which may be instructed to collect (e.g., aggregate) backhaul, midhaul and/or fronthaul data via wired communication, and report some part of that data back to the CN layer.

Referring to FIG. 8, at 840, the device (e.g., receiver(s) 312 or 322 or 352 or 362, transmitter(s) 314 or 324 or 354 or 364, network transceiver(s) 380 or 390, etc.) collects information associated with the device and the one or more other devices. For example, the information may include measurements of samples at multiple UEs at OTA layer. The measurement samples can be aggregated into a heterogeneity report that may then be sent back to the network component (e.g., the actual measurement data can be sent, or alternatively ‘gradient’-type information that conveys the differential of samples between UEs, as discussed above with respect to FIG. 6.

Referring to FIG. 8, at 850, the device (e.g., transmitter(s) 314 or 324 or 354 or 364, network transceiver(s) 380 or 390, etc.) reports data associated with the collected information to the network component in accordance with the data reporting instruction. As noted above, the reported data may include actual measurement data can be sent, or alternatively ‘gradient’-type information that conveys the differential of samples between UEs, as discussed above with respect to FIG. 6.

Referring to FIGS. 7-8, in some designs, depending on the network layer, the data may include wireless data (e.g., OTA, etc.) or non-wireless data (e.g., backhaul, fronthaul, and/or midhaul data). In some designs on the network side, RUs at RU layer may have the least general computation power which progressively increases at DUs and CUs. Accordingly, simple aggregation tasks may be performed in the RU and more complex functions can be implemented in the DU and the CU (e.g., likewise, simplest aggregation tasks may be implemented at power-limited UEs at OTA layer). For example, consider a positioning neural network (NN) which takes channel observations and outputs a position estimate. At the RU level, the channels are from a local area around the RU deployment and can be used to train some customizations to the positioning NN for the local area at the RU. However, at the CU layer or the DU layer, a generic NN can be trained using all the data aggregated from all the RUs and DUs.

Referring to FIGS. 7-8, in some designs as noted above, the heterogeneity level determination at 710 of FIG. 7 may be based upon a pre-configuration of the network layer. In this case, under the assumption that the network layer corresponds to OTA layer, the heterogeneity level determination at 710 of FIG. 7 may be performed without impact to the UEs (e.g., no heterogeneity metrics need to be reported to the network component). In some designs, the network component may not have direct access to the data (only the gradients), which may make it difficult for the network component to track data statistics.

Referring to FIGS. 7-8, in some designs as noted above, the heterogeneity level determination at 710 of FIG. 7 may be based upon a set of heterogeneity metrics received from one or more devices associated with the network layer. A computation rule for computing the set of heterogeneity metrics at the one or more devices is pre-defined, or the computation rule for computing the set of heterogeneity metrics at the one or more devices is signaled (e.g., via RRC) to the one or more devices by the network component. In some designs, the computation rule may be implemented via a neural network (NN) (e.g., a lightweight NN supported by a UE, etc.), which is described in more detail below with respect to FIG. 9. In some designs, UE computes the set of heterogeneity metrics with dataset available at the start of each communication round. For example, a distance between the output (or intermediate parameters) of a model update at round t vs. the last global model in a parameter server for round t-1 may be compared at each communication round to determine if the distancer exceeds a threshold (and if so, reporting of the heterogeneity metric is triggered to notify that network component that the network layer is heterogenous).

Referring to FIGS. 7-8, in some designs, the hierarchical network layer arrangement comprises an over the air (OTA) layer and one or more backhaul, midhaul or fronthaul component layers. For example, the one or more backhaul, midhaul or fronthaul component layers may include a remote unit (RU) layer, a distributed unit (DU) layer, a centralized unit (CU) layer, a core network (CN) layer, or any combination thereof.

Referring to FIGS. 7-8, in some designs, the at least one device (or the device performing the process of FIG. 8) corresponds to at least one user equipment (UE), and the network layer corresponds to an over the air (OTA) layer. For example, the network component can signal the UE to exchange (sparsified) datasets or gradients with nearby UEs in the neighborhood (e.g., sidelink communication). A designated anchor UE collects all the datasets/gradients from nearby UEs and performs computation. This reduces overall communication overhead and improves training outcomes. In some designs, different UEs can play the role of the anchor UE at various times to distribute the training load and power consumption. In some designs, SL sharing can be considered as the lowest level of sharing in the hierarchical network layer arrangement.

In a further example, the data from the at least one device is associated with gradients between radio frequency (RF) fingerprints at two or more UEs. For example, consider a dataset for RF fingerprinting may be collected by each UE. In some designs, each data point=(channel impulse response (CIR), Location/Location estimate). Typically, the data is non-i.i.d as the observation (latent variables) of each UE in an area is highly correlated (e.g., location of reflectors, etc.). In some designs, the network component can request UEs to communicate with each other and then jointly train before passing on the gradients (e.g., this is more efficient in many settings as sidelink communication is less power intensive than network communication).

Referring to FIGS. 7-8, in some designs, the data from the at least one device includes gradients between parameters or measurements at two or more devices associated with the network layer. In some designs, the network component is associated with a backhaul, midhaul or fronthaul component layer of the hierarchical network layer arrangement. In particular, the at least one device may include one or more user equipments (UEs) associated with an over-the-air (OTA) layer of the hierarchical network layer arrangement, or the at least one device may include one or more remote units (RUs) associated with an RU layer of the hierarchical network layer arrangement, or the at least one device may include one or more distributed units (DUs) associated with a DU layer of the hierarchical network layer arrangement, or the at least one device may include one or more centralized units (CUs) associated with a CU layer of the hierarchical network layer arrangement.

Generally, the RU, CU and DU layers may be characterized as “upper” layers, with the OTA layer being a “lower” layer. In some designs where the device corresponds to an upper layer device (e.g., RU/CU/DU), the network component may exchange the collected (sparsified) gradients among a small group of nearby RUs/DUs/CUs. This may improve the data statistics and corresponding training accuracy, and is generally transparent to the air interface (or OTA layer).

As noted above, the computation rule(s) by which the heterogeneity metric(s) may be computed at a respective layer may be implemented via a neural network (NN). Additional description associated with NNs (and machine learning in general) is now provided.

Machine learning may be used to generate models that may be used to facilitate various aspects associated with processing of data. One specific application of machine learning relates to generation of measurement models for processing of reference signals for positioning (e.g., PRS), such as feature extraction, reporting of reference signal measurements (e.g., selecting which extracted features to report), and so on.

Machine learning models are generally categorized as either supervised or unsupervised. A supervised model may further be sub-categorized as either a regression or classification model. Supervised learning involves learning a function that maps an input to an output based on example input-output pairs. For example, given a training dataset with two variables of age (input) and height (output), a supervised learning model could be generated to predict the height of a person based on their age. In regression models, the output is continuous. One example of a regression model is a linear regression, which simply attempts to find a line that best fits the data. Extensions of linear regression include multiple linear regression (e.g., finding a plane of best fit) and polynomial regression (e.g., finding a curve of best fit).

Another example of a machine learning model is a decision tree model. In a decision tree model, a tree structure is defined with a plurality of nodes. Decisions are used to move from a root node at the top of the decision tree to a leaf node at the bottom of the decision tree (i.e., a node with no further child nodes). Generally, a higher number of nodes in the decision tree model is correlated with higher decision accuracy.

Another example of a machine learning model is a decision forest. Random forests are an ensemble learning technique that builds off of decision trees. Random forests involve creating multiple decision trees using bootstrapped datasets of the original data and randomly selecting a subset of variables at each step of the decision tree. The model then selects the mode of all of the predictions of each decision tree. By relying on a “majority wins” model, the risk of error from an individual tree is reduced.

Another example of a machine learning model is a neural network (NN). A neural network is essentially a network of mathematical equations. Neural networks accept one or more input variables, and by going through a network of equations, result in one or more output variables. Put another way, a neural network takes in a vector of inputs and returns a vector of outputs.

FIG. 9 illustrates an example neural network 900, according to aspects of the disclosure. The neural network 900 includes an input layer ‘i’ that receives ‘n’ (one or more) inputs (illustrated as “Input 1,” “Input 2,” and “Input n”), one or more hidden layers (illustrated as hidden layers ‘h1,’ ‘h2,’ and ‘h3’) for processing the inputs from the input layer, and an output layer ‘o’ that provides ‘m’ (one or more) outputs (labeled “Output 1” and “Output m”). The number of inputs ‘n,’ hidden layers ‘h,’ and outputs ‘m’ may be the same or different. In some designs, the hidden layers ‘h’ may include linear function(s) and/or activation function(s) that the nodes (illustrated as circles) of each successive hidden layer process from the nodes of the previous hidden layer.

In classification models, the output is discrete. One example of a classification model is logistic regression. Logistic regression is similar to linear regression but is used to model the probability of a finite number of outcomes, typically two. In essence, a logistic equation is created in such a way that the output values can only be between ‘0’ and ‘1.0’ Another example of a classification model is a support vector machine. For example, for two classes of data, a support vector machine will find a hyperplane or a boundary between the two classes of data that maximizes the margin between the two classes. There are many planes that can separate the two classes, but only one plane can maximize the margin or distance between the classes. Another example of a classification model is Naïve Bayes, which is based on Bayes Theorem. Other examples of classification models include decision tree, random forest, and neural network, similar to the examples described above except that the output is discrete rather than continuous.

Unlike supervised learning, unsupervised learning is used to draw inferences and find patterns from input data without references to labeled outcomes. Two examples of unsupervised learning models include clustering and dimensionality reduction.

Clustering is an unsupervised technique that involves the grouping, or clustering, of data points. Clustering is frequently used for customer segmentation, fraud detection, and document classification. Common clustering techniques include k-means clustering, hierarchical clustering, mean shift clustering, and density-based clustering. Dimensionality reduction is the process of reducing the number of random variables under consideration by obtaining a set of principal variables. In simpler terms, dimensionality reduction is the process of reducing the dimension of a feature set (in even simpler terms, reducing the number of features). Most dimensionality reduction techniques can be categorized as either feature elimination or feature extraction. One example of dimensionality reduction is called principal component analysis (PCA). In the simplest sense, PCA involves project higher dimensional data (e.g., three dimensions) to a smaller space (e.g., two dimensions). This results in a lower dimension of data (e.g., two dimensions instead of three dimensions) while keeping all original variables in the model.

Regardless of which machine learning model is used, at a high-level, a machine learning module (e.g., implemented by a processing system, such as processors 332, 384, or 394) may be configured to iteratively analyze training input data (e.g., measurements of reference signals to/from various target UEs) and to associate this training input data with an output data set (e.g., a set of possible or likely candidate locations of the various target UEs), thereby enabling later determination of the same output data set when presented with similar input data (e.g., from other target UEs at the same or similar location).

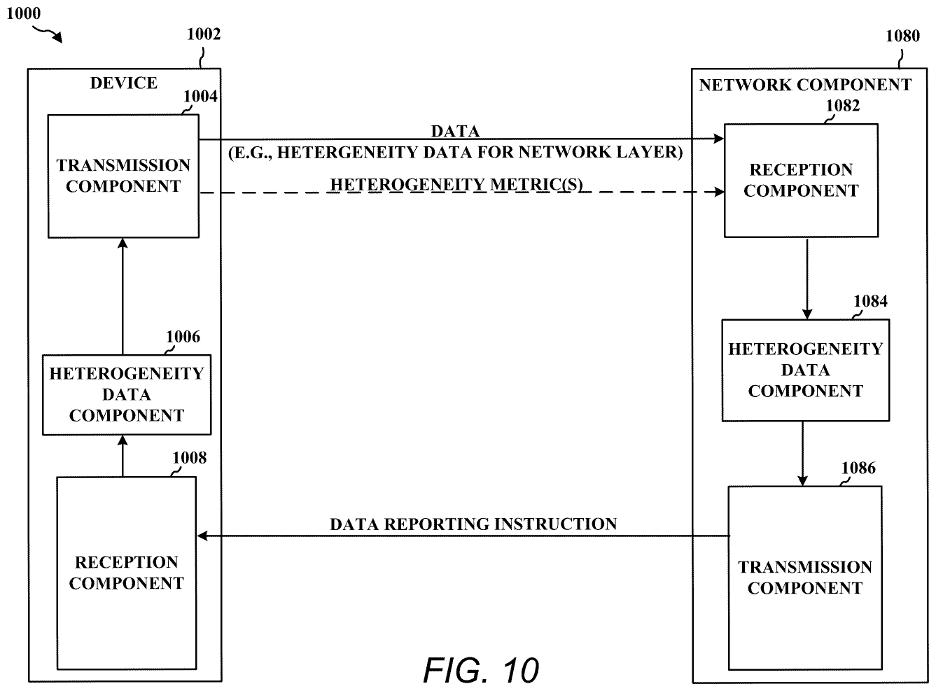

FIG. 10 is a conceptual data flow diagram 1000 illustrating the data flow between different means/components in exemplary apparatuses 1002 and 1080 in accordance with an aspect of the disclosure. The apparatus 1002 may be a device (e.g., UE 302 or BS 304 or network entity 306, such as RU 229 or DU 228 or CU 226, etc.) in communication with an apparatus 1080, which may be a network component (e.g., UE BS 304 or network entity 306, such as RU 229 or DU 228 or CU 226 or third party server 274, etc.).

The apparatus 1002 includes a transmission component 1004, which may correspond to transmitter circuitry in UE 302 or BS 304 as depicted in FIGS. 3A-3B, including transmitter(s) 314 or 324 or 354 or 364, antenna(s) 316 or 326 or 356 or 366, etc., or alternatively to transceiver(s) 380 and/or 390 of BS 304 or network entity 306 for wired network transmissions. The apparatus 1002 further includes heterogeneity data component 1006, which may correspond to processor circuitry in UE 302 or BS 304 or network entity 306, as depicted in FIGS. 3A-3C, including processing system 332 or 384 or 394, etc. The apparatus 1002 further includes a reception component 1008, which may correspond to receiver circuitry in UE 302 or BS 304 as depicted in FIGS. 3A-3B, including receiver(s) 312 or 322 or 352 or 362, antenna(s) 316 or 326 or 356 or 366, etc., or alternatively to transceiver(s) 380 and/or 390 of BS 304 or network entity 306 for wired network reception.

The apparatus 1080 includes a transmission component 1086, which may correspond to transmitter circuitry in BS 304 as depicted in FIG. 3B, including transmitter(s) 354 or 364, antenna(s) 356 or 366, etc., or alternatively to transceiver(s) 380 and/or 390 of BS 304 or network entity 306 for wired network transmissions. The apparatus 1080 further includes heterogeneity data component 1084, which may correspond to processor circuitry in BS 304 or network entity 306, as depicted in FIGS. 3B-3C, including processing system 384 or 394, etc. The apparatus 1080 further includes a reception component 1082, which may correspond to receiver circuitry in BS 304 as depicted in FIG. 3B, including receiver(s) 352 or 362, antenna(s) 356 or 366, etc., or alternatively to transceiver(s) 380 and/or 390 of BS 304 or network entity 306 for wired network reception.

Referring to FIG. 10, the heterogeneity data component 1084 determines that a level of heterogeneity associated with a network layer of a hierarchical network layer arrangement with multiple network layers is above a threshold. The transmission component 1084 transmits, to at least the reception component 1008 in response to the determination, a data reporting instruction associated with the network layer. In some designs, the heterogeneity data component 1006 receives the data reporting instruction associated with the network layer, and collects information associated with devices at the network layer. The transmission component 1004 reports data associated with the collected information to the network component in accordance with the data reporting instruction. In some designs, the heterogeneity level determination may be based upon a set of heterogeneity metrics associated with computed by the heterogeneity data component 1006, which may be transmitted by transmission component 1004 to reception component 1082 for consideration by the heterogeneity data component 1084.

One or more components of the apparatus 1002 and apparatus 1080 may perform each of the blocks of the algorithm in the aforementioned flowcharts of FIGS. 7-8. As such, each block in the aforementioned flowcharts of FIGS. 7-8 may be performed by a component and the apparatus 1002 and apparatus 1080 may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

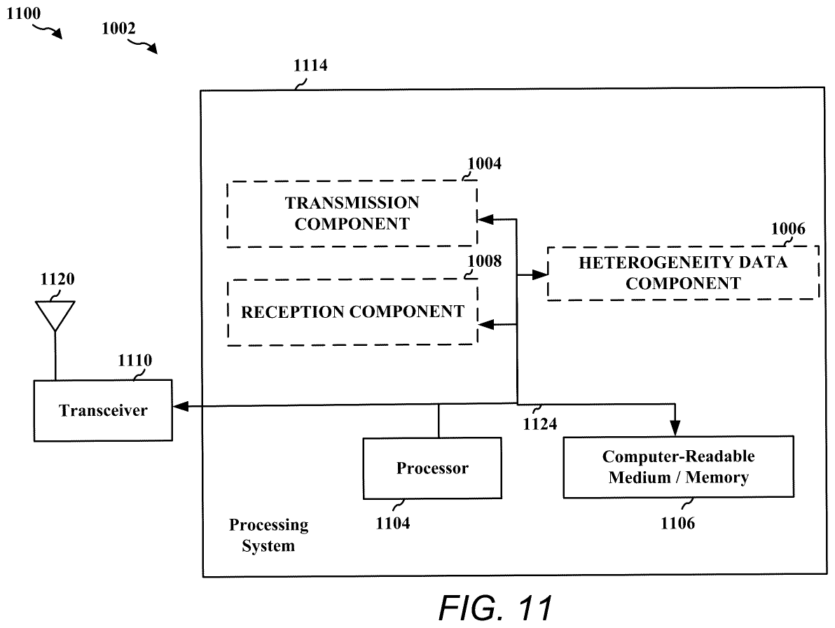

FIG. 11 is a diagram 1100 illustrating an example of a hardware implementation for an apparatus 1002 employing a processing system 1114. The processing system 1114 may be implemented with a bus architecture, represented generally by the bus 1124. The bus 1124 may include any number of interconnecting buses and bridges depending on the specific application of the processing system 1114 and the overall design constraints. The bus 1124 links together various circuits including one or more processors and/or hardware components, represented by the processor 1104, the components 1004, 1006 and 1008, and the computer-readable medium/memory 1106. The bus 1124 may also link various other circuits such as timing sources, peripherals, voltage regulators, and power management circuits, which are well known in the art, and therefore, will not be described any further.

The processing system 1114 may be coupled to a transceiver 1110. The transceiver 1110 is coupled to one or more antennas 1120. The transceiver 1110 provides a means for communicating with various other apparatus over a transmission medium. The transceiver 1110 receives a signal from the one or more antennas 1120, extracts information from the received signal, and provides the extracted information to the processing system 1114, specifically the reception component 1008. In addition, the transceiver 1110 receives information from the processing system 1114, specifically the transmission component 1004, and based on the received information, generates a signal to be applied to the one or more antennas 1120. The processing system 1114 includes a processor 1104 coupled to a computer-readable medium/memory 1106. The processor 1104 is responsible for general processing, including the execution of software stored on the computer-readable medium/memory 1106. The software, when executed by the processor 1104, causes the processing system 1114 to perform the various functions described supra for any particular apparatus. The computer-readable medium/memory 1106 may also be used for storing data that is manipulated by the processor 1104 when executing software. The processing system 1114 further includes at least one of the components 1004, 1006 and 1008. The components may be software components running in the processor 1104, resident/stored in the computer readable medium/memory 1106, one or more hardware components coupled to the processor 1104, or some combination thereof.

In one configuration, the apparatus 1002 includes means for determining that a level of heterogeneity associated with a network layer of a hierarchical network layer arrangement with multiple network layers is above a threshold, means for transmitting, to at least one device associated with the network layer in response to the determination, a data reporting instruction associated with the network layer, and means for receiving data associated with the network layer from the at least one device in accordance with the data reporting instruction

The aforementioned means may be one or more of the aforementioned components of the apparatus 1002 and/or the processing system 1114 of the apparatus 1002 configured to perform the functions recited by the aforementioned means.

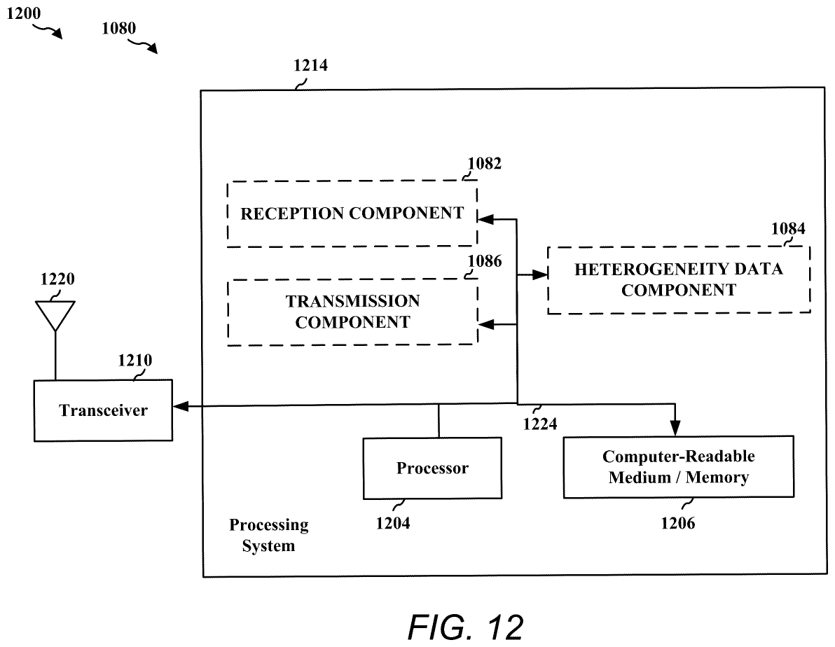

FIG. 12 is a diagram 1200 illustrating an example of a hardware implementation for an apparatus 1080 employing a processing system 1214. The processing system 1214 may be implemented with a bus architecture, represented generally by the bus 1224. The bus 1224 may include any number of interconnecting buses and bridges depending on the specific application of the processing system 1214 and the overall design constraints. The bus 1224 links together various circuits including one or more processors and/or hardware components, represented by the processor 1204, the components 1082, 1084 and 1086, and the computer-readable medium/memory 1206. The bus 1224 may also link various other circuits such as timing sources, peripherals, voltage regulators, and power management circuits, which are well known in the art, and therefore, will not be described any further.

The processing system 1214 may be coupled to a transceiver 1210. The transceiver 1210 is coupled to one or more antennas 1220. The transceiver 1210 provides a means for communicating with various other apparatus over a transmission medium. The transceiver 1210 receives a signal from the one or more antennas 1220, extracts information from the received signal, and provides the extracted information to the processing system 1214, specifically the reception component 1082. In addition, the transceiver 1210 receives information from the processing system 1214, specifically the transmission component 1086, and based on the received information, generates a signal to be applied to the one or more antennas 1220. The processing system 1214 includes a processor 1204 coupled to a computer-readable medium/memory 1206. The processor 1204 is responsible for general processing, including the execution of software stored on the computer-readable medium/memory 1206. The software, when executed by the processor 1204, causes the processing system 1214 to perform the various functions described supra for any particular apparatus. The computer-readable medium/memory 1206 may also be used for storing data that is manipulated by the processor 1204 when executing software. The processing system 1214 further includes at least one of the components 1082, 1084 and 1086. The components may be software components running in the processor 1204, resident/stored in the computer readable medium/memory 1206, one or more hardware components coupled to the processor 1204, or some combination thereof.

In one configuration, the apparatus 1080 may include means for computing a set of heterogeneity metrics associated with a network layer of a hierarchical network layer arrangement with multiple network layers, wherein the network layer includes the device and one or more other devices, wherein the set of level of heterogeneity metrics is indicative of a level of heterogeneity associated with the network layer being above a threshold, means for transmitting an indication of the set of heterogeneity metrics to a network component, means for receiving, a data reporting instruction associated with the network layer, means for collecting information associated with the device and the one or more other devices, and means for reporting data associated with the collected information to the network component in accordance with the data reporting instruction.

The aforementioned means may be one or more of the aforementioned components of the apparatus 1080 and/or the processing system 1214 of the apparatus 1080 configured to perform the functions recited by the aforementioned means.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an insulator and a conductor). Furthermore, it is also intended that aspects of a clause can be included in any other independent clause, even if the clause is not directly dependent on the independent clause.

Implementation examples are described in the following numbered clauses:

Clause 1. A method of operating a network component, comprising: determining that a level of heterogeneity associated with a network layer of a hierarchical network layer arrangement with multiple network layers is above a threshold; transmitting, to at least one device associated with the network layer in response to the determination, a data reporting instruction associated with the network layer; and receiving data associated with the network layer from the at least one device in accordance with the data reporting instruction.

Clause 2. The method of clause 1, wherein the heterogeneity level determination is based upon a pre-configuration of the network layer.

Clause 3. The method of any of clauses 1 to 2, wherein the heterogeneity level determination is based upon a set of heterogeneity metrics received from one or more devices associated with the network layer.

Clause 4. The method of clause 3, wherein a computation rule for computing the set of heterogeneity metrics at the one or more devices is pre-defined, or wherein the computation rule for computing the set of heterogeneity metrics at the one or more devices is signaled to the one or more devices by the network component.

Clause 5. The method of clause 4, wherein the computation rule is implemented via a neural network (NN).

Clause 6. The method of any of clauses 1 to 5, wherein the hierarchical network layer arrangement comprises an over the air (OTA) layer and one or more backhaul, midhaul or fronthaul component layers.

Clause 7. The method of clause 6, wherein the one or more backhaul, midhaul or fronthaul component layers comprise a remote unit (RU) layer, a distributed unit (DU) layer, a centralized unit (CU) layer, a core network (CN) layer, or any combination thereof.

Clause 8. The method of any of clauses 1 to 7, wherein the at least one device corresponds to at least one user equipment (UE), and wherein the network layer corresponds to an over the air (OTA) layer.

Clause 9. The method of clause 8, wherein the data from the at least one device is associated with gradients between radio frequency (RF) fingerprints at two or more UEs.

Clause 10. The method of any of clauses 1 to 9, wherein the data from the at least one device comprises gradients between parameters or measurements at two or more devices associated with the network layer.

Clause 11. The method of any of clauses 1 to 10, wherein the network component is associated with a backhaul, midhaul or fronthaul component layer of the hierarchical network layer arrangement.

Clause 12. The method of clause 11, wherein the at least one device comprises one or more user equipments (UEs) associated with an over-the-air (OTA) layer of the hierarchical network layer arrangement, or wherein the at least one device comprises one or more remote units (RUs) associated with an RU layer of the hierarchical network layer arrangement, or wherein the at least one device comprises one or more distributed units (DUs) associated with a DU layer of the hierarchical network layer arrangement, or wherein the at least one device comprises one or more centralized units (CUs) associated with a CU layer of the hierarchical network layer arrangement.

Clause 13. A method of operating a device, comprising: computing a set of heterogeneity metrics associated with a network layer of a hierarchical network layer arrangement with multiple network layers, wherein the network layer includes the device and one or more other devices, wherein the set of level of heterogeneity metrics is indicative of a level of heterogeneity associated with the network layer being above a threshold; transmitting an indication of the set of heterogeneity metrics to a network component; receiving, a data reporting instruction associated with the network layer; collecting information associated with the device and the one or more other devices; and reporting data associated with the collected information to the network component in accordance with the data reporting instruction.

Clause 14. The method of clause 13 wherein a computation rule for computing the set of heterogeneity metrics at the device is pre-defined, or wherein the computation rule for computing the set of heterogeneity metrics at the device is signaled to the device by the network component.

Clause 15. The method of clause 14, wherein the computation rule is implemented via a neural network (NN).

Clause 16. The method of any of clauses 13 to 15, wherein the hierarchical network layer arrangement comprises an over the air (OTA) layer and one or more backhaul, midhaul or fronthaul component layers.

Clause 17. The method of clause 16, wherein the one or more backhaul, midhaul or fronthaul component layers comprise a remote unit (RU) layer, a distributed unit (DU) layer, a centralized unit (CU) layer, a core network (CN) layer, or any combination thereof.

Clause 18. The method of any of clauses 13 to 17, wherein the device corresponds to at least one user equipment (UE), and wherein the network layer corresponds to an over the air (OTA) layer.

Clause 19. The method of clause 18, wherein the reported data is associated with gradients between radio frequency (RF) fingerprints at two or more UEs.

Clause 20. The method of any of clauses 13 to 19, wherein the reported data comprises gradients between parameters or measurements at two or more devices associated with the network layer.

Clause 21. The method of any of clauses 13 to 20, wherein the network component is associated with a backhaul, midhaul or fronthaul component layer of the hierarchical network layer arrangement.

Clause 22. The method of clause 21, wherein the device and the one or more other devices correspond to user equipments (UEs) associated with an over-the-air (OTA) layer of the hierarchical network layer arrangement, or wherein the device and the one or more other devices correspond to remote units (RUS) associated with an RU layer of the hierarchical network layer arrangement, or wherein the device and the one or more other devices correspond to distributed units (DUs) associated with a DU layer of the hierarchical network layer arrangement, or wherein the device and the one or more other devices correspond to centralized units (CUs) associated with a CU layer of the hierarchical network layer arrangement.

Clause 23. A network component, comprising: a memory; at least one transceiver; and at least one processor communicatively coupled to the memory and the at least one transceiver, the at least one processor configured to: determine that a level of heterogeneity associated with a network layer of a hierarchical network layer arrangement with multiple network layers is above a threshold; transmit, via the at least one transceiver, to at least one device associated with the network layer in response to the determination, a data reporting instruction associated with the network layer; and receive, via the at least one transceiver, data associated with the network layer from the at least one device in accordance with the data reporting instruction.

Clause 24. The network component of clause 23, wherein the heterogeneity level determination is based upon a pre-configuration of the network layer.

Clause 25. The network component of any of clauses 23 to 24, wherein the heterogeneity level determination is based upon a set of heterogeneity metrics received from one or more devices associated with the network layer.

Clause 26. The network component of clause 25, wherein a computation rule for computing the set of heterogeneity metrics at the one or more devices is pre-defined, or wherein the computation rule for computing the set of heterogeneity metrics at the one or more devices is signaled to the one or more devices by the network component.

Clause 27. The network component of clause 26, wherein the computation rule is implemented via a neural network (NN).

Clause 28. The network component of any of clauses 23 to 27, wherein the hierarchical network layer arrangement comprises an over the air (OTA) layer and one or more backhaul, midhaul or fronthaul component layers.

Clause 29. The network component of clause 28, wherein the one or more backhaul, midhaul or fronthaul component layers comprise a remote unit (RU) layer, a distributed unit (DU) layer, a centralized unit (CU) layer, a core network (CN) layer, or any combination thereof.

Clause 30. The network component of any of clauses 23 to 29, wherein the at least one device corresponds to at least one user equipment (UE), and wherein the network layer corresponds to an over the air (OTA) layer.

Clause 31. The network component of clause 30, wherein the data from the at least one device is associated with gradients between radio frequency (RF) fingerprints at two or more UEs.

Clause 32. The network component of any of clauses 23 to 31, wherein the data from the at least one device comprises gradients between parameters or measurements at two or more devices associated with the network layer.

Clause 33. The network component of any of clauses 23 to 32, wherein the network component is associated with a backhaul, midhaul or fronthaul component layer of the hierarchical network layer arrangement.

Clause 34. The network component of clause 33, wherein the at least one device comprises one or more user equipments (UEs) associated with an over-the-air (OTA) layer of the hierarchical network layer arrangement, or wherein the at least one device comprises one or more remote units (RUs) associated with an RU layer of the hierarchical network layer arrangement, or wherein the at least one device comprises one or more distributed units (DUs) associated with a DU layer of the hierarchical network layer arrangement, or wherein the at least one device comprises one or more centralized units (CUs) associated with a CU layer of the hierarchical network layer arrangement.

Clause 35. A device, comprising: a memory; at least one transceiver; and at least one processor communicatively coupled to the memory and the at least one transceiver, the at least one processor configured to: compute a set of heterogeneity metrics associated with a network layer of a hierarchical network layer arrangement with multiple network layers, wherein the network layer includes the device and one or more other devices, wherein the set of level of heterogeneity metrics is indicative of a level of heterogeneity associated with the network layer being above a threshold; transmit, via the at least one transceiver, an indication of the set of heterogeneity metrics to a network component; receive, via the at least one transceiver, a data reporting instruction associated with the network layer; collect information associated with the device and the one or more other devices; and report data associated with the collected information to the network component in accordance with the data reporting instruction.

Clause 36. The device of clause 35, wherein a computation rule for computing the set of heterogeneity metrics at the device is pre-defined, or wherein the computation rule for computing the set of heterogeneity metrics at the device is signaled to the device by the network component.

Clause 37. The device of clause 36, wherein the computation rule is implemented via a neural network (NN).

Clause 38. The device of any of clauses 35 to 37, wherein the hierarchical network layer arrangement comprises an over the air (OTA) layer and one or more backhaul, midhaul or fronthaul component layers.

Clause 39. The device of clause 38, wherein the one or more backhaul, midhaul or fronthaul component layers comprise a remote unit (RU) layer, a distributed unit (DU) layer, a centralized unit (CU) layer, a core network (CN) layer, or any combination thereof.

Clause 40. The device of any of clauses 35 to 39, wherein the device corresponds to at least one user equipment (UE), and wherein the network layer corresponds to an over the air (OTA) layer.

Clause 41. The device of clause 40, wherein the reported data is associated with gradients between radio frequency (RF) fingerprints at two or more UEs.

Clause 42. The device of any of clauses 35 to 41, wherein the reported data comprises gradients between parameters or measurements at two or more devices associated with the network layer.

Clause 43. The device of any of clauses 35 to 42, wherein the network component is associated with a backhaul, midhaul or fronthaul component layer of the hierarchical network layer arrangement.

Clause 44. The device of clause 43, wherein the device and the one or more other devices correspond to user equipments (UEs) associated with an over-the-air (OTA) layer of the hierarchical network layer arrangement, or wherein the device and the one or more other devices correspond to remote units (RUs) associated with an RU layer of the hierarchical network layer arrangement, or wherein the device and the one or more other devices correspond to distributed units (DUs) associated with a DU layer of the hierarchical network layer arrangement, or wherein the device and the one or more other devices correspond to centralized units (CUs) associated with a CU layer of the hierarchical network layer arrangement.

Clause 45. A network component, comprising: means for determining that a level of heterogeneity associated with a network layer of a hierarchical network layer arrangement with multiple network layers is above a threshold; means for transmitting, to at least one device associated with the network layer in response to the determination, a data reporting instruction associated with the network layer; and means for receiving data associated with the network layer from the at least one device in accordance with the data reporting instruction.

Clause 46. The network component of clause 45, wherein the heterogeneity level determination is based upon a pre-configuration of the network layer.

Clause 47. The network component of any of clauses 45 to 46, wherein the heterogeneity level determination is based upon a set of heterogeneity metrics received from one or more devices associated with the network layer.

Clause 48. The network component of clause 47, wherein a computation rule for computing the set of heterogeneity metrics at the one or more devices is pre-defined, or wherein the computation rule for computing the set of heterogeneity metrics at the one or more devices is signaled to the one or more devices by the network component.

Clause 49. The network component of clause 48, wherein the computation rule is implemented via a neural network (NN).

Clause 50. The network component of any of clauses 45 to 49, wherein the hierarchical network layer arrangement comprises an over the air (OTA) layer and one or more backhaul, midhaul or fronthaul component layers.

Clause 51. The network component of clause 50, wherein the one or more backhaul, midhaul or fronthaul component layers comprise a remote unit (RU) layer, a distributed unit (DU) layer, a centralized unit (CU) layer, a core network (CN) layer, or any combination thereof.

Clause 52. The network component of any of clauses 45 to 51, wherein the at least one device corresponds to at least one user equipment (UE), and wherein the network layer corresponds to an over the air (OTA) layer.

Clause 53. The network component of clause 52, wherein the data from the at least one device is associated with gradients between radio frequency (RF) fingerprints at two or more UEs.

Clause 54. The network component of any of clauses 45 to 53, wherein the data from the at least one device comprises gradients between parameters or measurements at two or more devices associated with the network layer.

Clause 55. The network component of any of clauses 45 to 54, wherein the network component is associated with a backhaul, midhaul or fronthaul component layer of the hierarchical network layer arrangement.

Clause 56. The network component of clause 55, wherein the at least one device comprises one or more user equipments (UEs) associated with an over-the-air (OTA) layer of the hierarchical network layer arrangement, or wherein the at least one device comprises one or more remote units (RUs) associated with an RU layer of the hierarchical network layer arrangement, or wherein the at least one device comprises one or more distributed units (DUs) associated with a DU layer of the hierarchical network layer arrangement, or wherein the at least one device comprises one or more centralized units (CUs) associated with a CU layer of the hierarchical network layer arrangement.

Clause 57. A device, comprising: means for computing a set of heterogeneity metrics associated with a network layer of a hierarchical network layer arrangement with multiple network layers, wherein the network layer includes the device and one or more other devices, wherein the set of level of heterogeneity metrics is indicative of a level of heterogeneity associated with the network layer being above a threshold; means for transmitting an indication of the set of heterogeneity metrics to a network component; means for receiving, a data reporting instruction associated with the network layer; means for collecting information associated with the device and the one or more other devices; and means for reporting data associated with the collected information to the network component in accordance with the data reporting instruction.

Clause 58. The device of clause 57, wherein a computation rule for computing the set of heterogeneity metrics at the device is pre-defined, or wherein the computation rule for computing the set of heterogeneity metrics at the device is signaled to the device by the network component.

Clause 59. The device of clause 58, wherein the computation rule is implemented via a neural network (NN).

Clause 60. The device of any of clauses 57 to 59, wherein the hierarchical network layer arrangement comprises an over the air (OTA) layer and one or more backhaul, midhaul or fronthaul component layers.

Clause 61. The device of clause 60, wherein the one or more backhaul, midhaul or fronthaul component layers comprise a remote unit (RU) layer, a distributed unit (DU) layer, a centralized unit (CU) layer, a core network (CN) layer, or any combination thereof.

Clause 62. The device of any of clauses 57 to 61, wherein the device corresponds to at least one user equipment (UE), and wherein the network layer corresponds to an over the air (OTA) layer.

Clause 63. The device of clause 62, wherein the reported data is associated with gradients between radio frequency (RF) fingerprints at two or more UEs.

Clause 64. The device of any of clauses 57 to 63, wherein the reported data comprises gradients between parameters or measurements at two or more devices associated with the network layer.

Clause 65. The device of any of clauses 57 to 64, wherein the network component is associated with a backhaul, midhaul or fronthaul component layer of the hierarchical network layer arrangement.

Clause 66. The device of clause 65, wherein the device and the one or more other devices correspond to user equipments (UEs) associated with an over-the-air (OTA) layer of the hierarchical network layer arrangement, or wherein the device and the one or more other devices correspond to remote units (RUs) associated with an RU layer of the hierarchical network layer arrangement, or wherein the device and the one or more other devices correspond to distributed units (DUs) associated with a DU layer of the hierarchical network layer arrangement, or wherein the device and the one or more other devices correspond to centralized units (CUs) associated with a CU layer of the hierarchical network layer arrangement.

Clause 67. A non-transitory computer-readable medium storing computer-executable instructions that, when executed by a network component, cause the network component to: determine that a level of heterogeneity associated with a network layer of a hierarchical network layer arrangement with multiple network layers is above a threshold; transmit, to at least one device associated with the network layer in response to the determination, a data reporting instruction associated with the network layer; and receive data associated with the network layer from the at least one device in accordance with the data reporting instruction.

Clause 68. The non-transitory computer-readable medium of clause 67, wherein the heterogeneity level determination is based upon a pre-configuration of the network layer.

Clause 69. The non-transitory computer-readable medium of any of clauses 67 to 68, wherein the heterogeneity level determination is based upon a set of heterogeneity metrics received from one or more devices associated with the network layer.

Clause 70. The non-transitory computer-readable medium of clause 69, wherein a computation rule for computing the set of heterogeneity metrics at the one or more devices is pre-defined, or wherein the computation rule for computing the set of heterogeneity metrics at the one or more devices is signaled to the one or more devices by the network component.

Clause 71. The non-transitory computer-readable medium of clause 70, wherein the computation rule is implemented via a neural network (NN).

Clause 72. The non-transitory computer-readable medium of any of clauses 67 to 71, wherein the hierarchical network layer arrangement comprises an over the air (OTA) layer and one or more backhaul, midhaul or fronthaul component layers.

Clause 73. The non-transitory computer-readable medium of clause 72, wherein the one or more backhaul, midhaul or fronthaul component layers comprise a remote unit (RU) layer, a distributed unit (DU) layer, a centralized unit (CU) layer, a core network (CN) layer, or any combination thereof.

Clause 74. The non-transitory computer-readable medium of any of clauses 67 to 73, wherein the at least one device corresponds to at least one user equipment (UE), and wherein the network layer corresponds to an over the air (OTA) layer.

Clause 75. The non-transitory computer-readable medium of clause 74, wherein the data from the at least one device is associated with gradients between radio frequency (RF) fingerprints at two or more UEs.

Clause 76. The non-transitory computer-readable medium of any of clauses 67 to 75, wherein the data from the at least one device comprises gradients between parameters or measurements at two or more devices associated with the network layer.

Clause 77. The non-transitory computer-readable medium of any of clauses 67 to 76, wherein the network component is associated with a backhaul, midhaul or fronthaul component layer of the hierarchical network layer arrangement.

Clause 78. The non-transitory computer-readable medium of clause 77, wherein the at least one device comprises one or more user equipments (UEs) associated with an over-the-air (OTA) layer of the hierarchical network layer arrangement, or wherein the at least one device comprises one or more remote units (RUs) associated with an RU layer of the hierarchical network layer arrangement, or wherein the at least one device comprises one or more distributed units (DUs) associated with a DU layer of the hierarchical network layer arrangement, or wherein the at least one device comprises one or more centralized units (CUs) associated with a CU layer of the hierarchical network layer arrangement.

Clause 79. A non-transitory computer-readable medium storing computer-executable instructions that, when executed by a device, cause the device to: compute a set of heterogeneity metrics associated with a network layer of a hierarchical network layer arrangement with multiple network layers, wherein the network layer includes the device and one or more other devices, wherein the set of level of heterogeneity metrics is indicative of a level of heterogeneity associated with the network layer being above a threshold; transmit an indication of the set of heterogeneity metrics to a network component; receive, a data reporting instruction associated with the network layer; collect information associated with the device and the one or more other devices; and report data associated with the collected information to the network component in accordance with the data reporting instruction.

Clause 80. The non-transitory computer-readable medium of clause 79, wherein a computation rule for computing the set of heterogeneity metrics at the device is pre-defined, or wherein the computation rule for computing the set of heterogeneity metrics at the device is signaled to the device by the network component.

Clause 81. The non-transitory computer-readable medium of clause 80, wherein the computation rule is implemented via a neural network (NN).

Clause 82. The non-transitory computer-readable medium of any of clauses 79 to 81, wherein the hierarchical network layer arrangement comprises an over the air (OTA) layer and one or more backhaul, midhaul or fronthaul component layers.

Clause 83. The non-transitory computer-readable medium of clause 82, wherein the one or more backhaul, midhaul or fronthaul component layers comprise a remote unit (RU) layer, a distributed unit (DU) layer, a centralized unit (CU) layer, a core network (CN) layer, or any combination thereof.

Clause 84. The non-transitory computer-readable medium of any of clauses 79 to 83, wherein the device corresponds to at least one user equipment (UE), and wherein the network layer corresponds to an over the air (OTA) layer.

Clause 85. The non-transitory computer-readable medium of clause 84, wherein the reported data is associated with gradients between radio frequency (RF) fingerprints at two or more UEs.

Clause 86. The non-transitory computer-readable medium of any of clauses 79 to 85, wherein the reported data comprises gradients between parameters or measurements at two or more devices associated with the network layer.

Clause 87. The non-transitory computer-readable medium of any of clauses 79 to 86, wherein the network component is associated with a backhaul, midhaul or fronthaul component layer of the hierarchical network layer arrangement.

Clause 88. The non-transitory computer-readable medium of clause 87, wherein the device and the one or more other devices correspond to user equipments (UEs) associated with an over-the-air (OTA) layer of the hierarchical network layer arrangement, or wherein the device and the one or more other devices correspond to remote units (RUs) associated with an RU layer of the hierarchical network layer arrangement, or wherein the device and the one or more other devices correspond to distributed units (DUs) associated with a DU layer of the hierarchical network layer arrangement, or wherein the device and the one or more other devices correspond to centralized units (CUs) associated with a CU layer of the hierarchical network layer arrangement.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programmable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A network component, comprising:
a memory;
at least one transceiver; and
at least one processor communicatively coupled to the memory and the at least one transceiver, the at least one processor configured to:
determine that a level of heterogeneity associated with a network layer of a hierarchical network layer arrangement with multiple network layers is above a threshold;
transmit, via the at least one transceiver, to at least one device associated with the network layer in response to the determination, a data reporting instruction associated with the network layer; and
receive, via the at least one transceiver, data associated with the network layer from the at least one device in accordance with the data reporting instruction.

2. The network component of claim 1, wherein the heterogeneity level determination is based upon a pre-configuration of the network layer.

3. The network component of claim 1, wherein the heterogeneity level determination is based upon a set of heterogeneity metrics received from one or more devices associated with the network layer.

4. The network component of claim 3,
wherein a computation rule for computing the set of heterogeneity metrics at the one or more devices is pre-defined, or
wherein the computation rule for computing the set of heterogeneity metrics at the one or more devices is signaled to the one or more devices by the network component.

5. The network component of claim 4, wherein the computation rule is implemented via a neural network (NN).

6. The network component of claim 1, wherein the hierarchical network layer arrangement comprises an over the air (OTA) layer and one or more backhaul, midhaul or fronthaul component layers.

7. The network component of claim 6, wherein the one or more backhaul, midhaul or fronthaul component layers comprise a remote unit (RU) layer, a distributed unit (DU) layer, a centralized unit (CU) layer, a core network (CN) layer, or any combination thereof.

8. The network component of claim 1,
wherein the at least one device corresponds to at least one user equipment (UE), and
wherein the network layer corresponds to an over the air (OTA) layer.

9. The network component of claim 8, wherein the data from the at least one device is associated with gradients between radio frequency (RF) fingerprints at two or more UEs.

10. The network component of claim 1, wherein the data from the at least one device comprises gradients between parameters or measurements at two or more devices associated with the network layer.

11. The network component of claim 1, wherein the network component is associated with a backhaul, midhaul or fronthaul component layer of the hierarchical network layer arrangement.

12. The network component of claim 11,
wherein the at least one device comprises one or more user equipments (UEs) associated with an over-the-air (OTA) layer of the hierarchical network layer arrangement, or
wherein the at least one device comprises one or more remote units (RUs) associated with an RU layer of the hierarchical network layer arrangement, or
wherein the at least one device comprises one or more distributed units (DUs) associated with a DU layer of the hierarchical network layer arrangement, or
wherein the at least one device comprises one or more centralized units (CUs) associated with a CU layer of the hierarchical network layer arrangement.

13. A device, comprising:
a memory;
at least one transceiver; and
at least one processor communicatively coupled to the memory and the at least one transceiver, the at least one processor configured to:
compute a set of heterogeneity metrics associated with a network layer of a hierarchical network layer arrangement with multiple network layers, wherein the network layer includes the device and one or more other devices, wherein the set of level of heterogeneity metrics is indicative of a level of heterogeneity associated with the network layer being above a threshold;
transmit, via the at least one transceiver, an indication of the set of heterogeneity metrics to a network component;
receive, via the at least one transceiver, a data reporting instruction associated with the network layer;
collect information associated with the device and the one or more other devices; and
report data associated with the collected information to the network component in accordance with the data reporting instruction.

14. The device of claim 13,
wherein a computation rule for computing the set of heterogeneity metrics at the device is pre-defined, or
wherein the computation rule for computing the set of heterogeneity metrics at the device is signaled to the device by the network component.

15. The device of claim 14, wherein the computation rule comprises a neural network (NN).

16. The device of claim 13, wherein the hierarchical network layer arrangement comprises an over the air (OTA) layer and one or more backhaul, midhaul or fronthaul component layers.

17. The device of claim 16, wherein the one or more backhaul, midhaul or fronthaul component layers comprise a remote unit (RU) layer, a distributed unit (DU) layer, a centralized unit (CU) layer, a core network (CN) layer, or any combination thereof.

18. The device of claim 13,
wherein the device corresponds to at least one user equipment (UE), and
wherein the network layer corresponds to an over the air (OTA) layer.

19. The device of claim 18, wherein the reported data is associated with gradients between radio frequency (RF) fingerprints at two or more UEs.

20. The device of claim 13, wherein the reported data comprises gradients between parameters or measurements at two or more devices associated with the network layer.

21. The device of claim 13, wherein the network component is associated with a backhaul, midhaul or fronthaul component layer of the hierarchical network layer arrangement.

22. The device of claim 21,
wherein the device and the one or more other devices correspond to user equipments (UEs) associated with an over-the-air (OTA) layer of the hierarchical network layer arrangement, or
wherein the device and the one or more other devices correspond to remote units (RUs) associated with an RU layer of the hierarchical network layer arrangement, or
wherein the device and the one or more other devices correspond to distributed units (DUs) associated with a DU layer of the hierarchical network layer arrangement, or
wherein the device and the one or more other devices correspond to centralized units (CUs) associated with a CU layer of the hierarchical network layer arrangement.

23. A method of operating a network component, comprising:
determining that a level of heterogeneity associated with a network layer of a hierarchical network layer arrangement with multiple network layers is above a threshold;
transmitting, to at least one device associated with the network layer in response to the determination, a data reporting instruction associated with the network layer; and
receiving data associated with the network layer from the at least one device in accordance with the data reporting instruction.

24. The method of claim 23, wherein the heterogeneity level determination is based upon a pre-configuration of the network layer.

25. The method of claim 23, wherein the heterogeneity level determination is based upon a set of heterogeneity metrics received from one or more devices associated with the network layer.

26. The method of claim 23, wherein the hierarchical network layer arrangement comprises an over the air (OTA) layer and one or more backhaul, midhaul or fronthaul component layers.

27. The method of claim 23, wherein the data from the at least one device comprises gradients between parameters or measurements at two or more devices associated with the network layer.

28. A method of operating a device, comprising:
computing a set of heterogeneity metrics associated with a network layer of a hierarchical network layer arrangement with multiple network layers, wherein the network layer includes the device and one or more other devices, wherein the set of level of heterogeneity metrics is indicative of a level of heterogeneity associated with the network layer being above a threshold;
transmitting an indication of the set of heterogeneity metrics to a network component;
receiving, a data reporting instruction associated with the network layer;
collecting information associated with the device and the one or more other devices; and
reporting data associated with the collected information to the network component in accordance with the data reporting instruction.

29. The method of claim 28,
wherein a computation rule for computing the set of heterogeneity metrics at the device is pre-defined, or
wherein the computation rule for computing the set of heterogeneity metrics at the device is signaled to the device by the network component.

30. The method of claim 28, wherein the reported data comprises gradients between parameters or measurements at two or more devices associated with the network layer.
